(19) United States
(12) Patent Application Publication
(10) Pub. No.: US 2003/0200108 A1
(43) Pub. Date: Oct. 23, 2003

(54) Master dispenser display with multiple communication interfaces allowing virtual transaction ticket

(76) Inventor: Michel Malnoe, Saint-Samson (FR)

Correspondence Address: RANDALL J. KNUTH P.C., 3510-A STELLHORN ROAD, FORT WAYNE, IN, 46815-4631, US

(21) Appl. No.: 10/364,538

(22) Filed: Feb. 10, 2003

Related U.S. Application Data
(60) Provisional application No. 60/355,873, filed on Feb. 11, 2002.

(51) Int. Cl. G06F 17/60

(52) U.S. Cl. 705/1

(57) ABSTRACT

An electronic refueling transaction receipt is generated at a fuel dispenser position. The electronic receipt can be wirelessly communicated to a user device associated with the refueling customer. The electronic receipt can also be communicated to a remote location such as a network address or e-mail account. For this purpose, the user device communicates to the fuel dispenser a destination address specifying the location where the dispenser should transmit the virtual receipt, such as an e-mail address. The user device can direct the execution of remote management functions involving the fuel dispenser. The communication exchange to facilitate the management operations includes the use of a wireless link between the dispenser and user device. The remote management tasks include diagnostics and calibration.

### CROSS-REFERENCE TO RELATED APPLICATIONS

This application claims the benefit of U.S. Provisional Patent Application No. 60/355,873 filed Feb. 11, 2002.

### BACKGROUND OF THE INVENTION

1. Field of the Invention

The present invention relates to a method and apparatus utilizing a wireless device to connect to a device utilized for conducting transactions and once the transaction is completed, the wireless device instructs the device utilized for conducting transactions to transfer an electronic ticket with details of the transaction to a particular location. Also, the present invention relates to a method and apparatus for diagnosing and calibrating the device utilized for conducting transactions.

2. Description of the Related Art

When conducting a transaction with a device, such as a fuel dispenser, a receipt is printed to detail the fueling transaction. The receipt is printed on paper and the customer collects the receipt to update the customer's financial records when the customer arrives to the customer's destination. One problem with paper receipts is that only one receipt is printed for the customer for each fueling transaction. If that receipt is misplaced, the customer has no record of the fueling transaction. Also, the collection of receipts from each fueling transaction can become burdensome and difficult to organize.

Another problem is that if the customer is an employee of a company, receipts need to be collected by the employee and filed with an expense report for the employee to be reimbursed by the employee's company for the cost of the fueling transactions. If the employee has lost the receipt for the fueling transaction, the employee will not be reimbursed for the fueling transaction.

Another problem with paper receipts is that they are typically printed in either the Metric System or the English System based on the geographic location of the fuel dispenser. The customer receiving the receipt may only understand the Metric System and the receipt can be printed in the English System or vice versa.

A further problem with the prior art is that if there is a problem diagnosed with a component of the fuel dispenser, the component must be removed from the fuel dispenser and sent to the component manufacturer for calibration. By sending the component to the manufacturer, the fuel dispenser cannot be used by customers unless a replacement component is in the inventory of the fuel dispenser owner. It can be expensive to keep an inventory for each component. The present invention solves these problems.

### SUMMARY OF THE INVENTION

According to the present invention, in one form thereof, there is provided a method and system in use with a fuel dispenser position to enable a refueling customer or other user to either receive or to specify a destination to receive a virtual transaction receipt, namely, a non-printed refueling transaction receipt or ticket constituted, for example, as an electronic signal adapted for wireless communication or network communication.

In one configuration, a user device is provided that is preferably associated with a refueling customer. In preferred forms, the user device is a mobile or cellular unit such as a Palm Pilot or other comparable device having a wireless transmit and/or receive capability, e.g., an RF or cellular transceiver. The dispenser position is configured to generate the virtual transaction receipt. The dispenser position communicates the transaction receipt to the user device and/or a location different from the user device. For example, the location could be an e-mail account of the user or a network address such as an Internet server designation.

The dispenser position may carry out its communication tasks according to a variety of protocols. For example, the dispenser position may be instructed at the outset of its wireless connection with the user device to send the virtual receipt to the user device. This instruction could be forwarded by the user device to the dispenser position upon initiation of the wireless link therebetween. Alternately, in the absence of counter instructions, the dispenser position may be configured in a default user-transmit mode so that it automatically transmits the virtual receipt to the user device.

Additionally, the dispenser position may be instructed by the user device to send the virtual receipt to a destination specified by the user device. This specification may take any of various forms, such as an e-mail address or network location. For this purpose, the dispenser position would be adapted with suitable connection means to enable communication of the virtual receipt to the specified destination. For example, if the destination is an e-mail account, the dispenser position would be equipped in a known manner with an appropriate internet browser and an interface to the internet, e.g., a modem or full-time connection to an internet network service provider (e.g., AOL or a proprietary network service).

The user device is also configured to furnish the dispenser position with information to facilitate the refueling transaction. For example, the user device can transmit to the dispenser position refueling parameters (e.g., type and amount of fuel for purchase) and payment or billing data (e.g., credit card account, debit card account, prepay, and digital cash). This information may be embodied in a user profile constituted as a file or unitized record that is downloadable to the dispenser position so that all of the relevant information is received at once.

Accordingly, various levels of automation can be implemented in the dispenser depending upon the scope of information sent from the user device. For example, if both refueling parameter selections and payment data are sent to the user device, the dispenser is thereby in receipt of all of the information needed to carry out the refueling transaction. In particular, the dispenser can request payment authorization, configure and activate the refueling components according to the user parameter selections, and debit or credit the appropriate account when the transaction is completed.

According to another form of the invention, the user device can be configured to facilitate the performance of various non-transaction related tasks and operations in relation to the fuel dispenser position. Among these tasks are functionalities including, but not limited to, diagnostics, calibration, configuration, monitoring, and maintenance. In one form, the user device would be adapted to include the instruction and command sets needed to query and establish the appropriate dialogue with the dispenser position to carry out the various indicated tasks. Additionally, any re-calibration and reconfiguration settings and values could be stored on the user device and made available to the dispenser position, if needed or desired.

According to another form of the invention, the fuel dispenser position may be configured as a single board design or construction where the various functional parts of the dispenser environment are consolidated or integrated into a master terminal or display. Additionally, the master display is adapted to offer a universal communications connection that is capable of adaptively interfacing to any type of local environment, e.g., multi-vendor POS terminals. Accordingly, the communications interface can accommodate connection to multiple different vendor facilities.

As used herein, references to a virtual transaction receipt or ticket should be understood as encompassing a record or other suitable representation or indication of a refueling transaction that appears or is present or embodied in a form other than conventional forms, namely, a printed or hard-copy media. For example, a virtual transaction receipt may be represented in electronic form and adapted for communication over a wireless link.

In one form, the virtual receipt may be configured as an electronic receipt. As used herein, electronic receipt should be understood as encompassing both a wired and a wireless signal embodiment. When in electronic form, the virtual receipt may be constituted in any of various forms, such as a computer file, computer document, message, message attachment, data string, web-compliant format (e.g., HTML document), serial or packet transmission, or computer-readable or machine-readable form.

For example, in one configuration, the electronic receipt will be adapted for transmission from the dispenser position to the user device over a wireless communications link. For this purpose, then, the electronic receipt will be constituted as a suitable RF or wireless signal. Alternately, in another configuration, the electronic receipt will be adapted for transmission from the dispenser position to a network address (e.g., Internet server) over a wired communications link. For this purpose, then, the electronic receipt will be constituted as a suitable digital signal capable of transport over the network topology typical of the Internet and/or World Wide Web. Analog signal embodiments are also possible for the electronic receipt.

In one form, the virtual receipt will embody all of the information that otherwise appears in a conventional printed refueling receipt, e.g., date, time, location, vendor, quantity of fuel dispensed, total value of purchase, unit price of fuel, and payment indicia (e.g., partial enumeration of credit card number or cash purchase).

As used herein, references to dispenser-related parameter data and/or information, and refueling parameters and/or information should be understood as encompassing the information used by a dispenser to control and manage a refueling operation. For example, such information would include, but is not limited to, data indicating the type and grade of fuel, amount of fuel (e.g., in volume measure), and purchase amount (e.g., in monetary measure).

As used herein, references to billing and/or payment data and/or information should be understood as encompassing the information used in a dispenser environment to facilitate the financial aspect of the refueling transaction, i.e., receive payment for dispensed fuel. For example, such information would include, but is not limited to, credit card account number, debit card account number, coupon information, discount information, prepay information, third-party billing data (e.g., employer account), digital cash, and purchase amount.

As used herein, references to a user device should be understood as encompassing any facility adapted for communication with a communications functionality provided at the dispenser position. For example, the user device may include, without limitation, a Palm Pilot, a cellular-mobile phone, a laptop, a PDA (Personal Digital Assistant), a transceiver, and a pager. In one form, the user device exhibits the features of a portable, hand-held mobile unit that is easily transported by the customer.

In a preferred form, the user device will communicate wirelessly with the dispenser position, which will also have a wireless communications functionality. For this purpose, for example, the user device and dispenser position will be respectively equipped with suitable RF transceiver units, such as conventional types known to those skilled in the art.

As used herein, references to remote sites, locations or positions should be understood as encompassing facilities apart from the particular dispenser position where the subject refueling operation and issuance of the virtual transaction receipt are taking place. For example, a remote site could include a facility within the refueling environment or fueling station, such as an operator terminal, on-site terminal, or point-of-sale (POS) facility. In this example, the remote site would be local in the context of being part of the discrete refueling environment where the subject refueling operation is occurring. Alternately, a remote site could include a facility located outside the current refueling environment or fueling station, such as a server accessed via a network such as the Internet or World Wide Web (WWW).

As used herein, references to remote management functions should be understood as encompassing the functions and operations directed by the user device in relation to the fuel dispenser position. In particular, according to the invention, the user device can be adapted to remotely direct the performance of a variety of tasks in the fuel dispenser position, including, but not limited to, diagnostics, calibration, parameter reconfiguration, monitoring (e.g., status and condition), and maintenance/servicing. Accordingly, these dispenser-based tasks can be remotely managed from the user device, preferably in conjunction with a wireless communications link between the user device and dispenser position.

In alternate forms, the remote management functions may be understood to encompass non-refueling transaction related tasks and operations.

One advantage of the present invention is that the tickets, such as receipts, can be transmitted electronically to a number of locations including the customer's wireless device, the customer's home, the customer's banking institution, as well as the customer's place of employment. Having the option of transmitting the ticket to multiple locations protects the customer in the situation that there is a computer problem at one location wherein that location does not receive the ticket. The ticket can still be retrieved from one of the other locations. Also, by using an electronic ticket, there is no opportunity to misplace the paper ticket and no space is required in a filing cabinet or other storage device to retain the paper tickets from all of the fueling transactions.

Another advantage of the present invention is that by transmitting the electronic ticket to the customer's banking institution or creditor for debiting as each transaction occurs, monthly bills can be eliminated. Therefore, without having to pay a monthly invoice, there is no risk of failing to pay the monthly invoice and being charged a penalty.

Another advantage of the present invention is that multiple individuals can have the electronic ticket transmitted to one location. This allows employees of a company to transmit each electronic ticket to the accounting department of their employer so that accurate accounting records can be maintained by the employer. By having the electronic ticket sent to the accounting department, the employee does not have out-of-pocket expenses that have to be reimbursed by their employer. Also, it is beneficial to the accounting department of an employer, as the accounting department will receive the electronic ticket as soon as the fueling transaction occurs.

Yet another advantage of the present invention is that the measurement information on the electronic ticket can be converted between the Metric System and English System. This feature is helpful to a customer who only understands one of the systems but not the other system.

Another advantage of the present invention is that any problems with the components of the fuel dispenser can be diagnosed and the components can be calibrated utilizing the wireless device. Typically, the component having a problem and requiring calibration would need to be sent to the manufacturer. This scenario causes additional expense for the fuel dispenser owner because the fuel dispenser owner needs to purchase additional components while the other component is being calibrated, or otherwise not use the fuel dispenser which causes a loss of income for the owner.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a block diagram schematic view of a system that facilitates issuance of a virtual refueling transaction receipt and its transmission to a user device and/or remote site, according to one form of the invention;

FIG. 2 is a block diagram schematic view showing an enhancement to the system of FIG. 1, according to the invention;

FIGS. 3-5 illustrate various process flow diagrams depicting several possible communication protocols facilitating transfer of the virtual refueling transaction receipt from the dispenser position to the user device, in conjunction with the system of FIG. 1, according to one operational mode of the invention;

FIGS. 6-8 illustrate various process flow diagrams depicting several possible communication protocols facilitating transfer of the virtual refueling transaction receipt from the dispenser position to a remote location, in conjunction with the system of FIG. 1, according to another operational mode of the invention;

FIG. 9 is a block diagram schematic view of one possible network scenario for use in practicing the process flow diagram depicted in FIG. 8, according to the invention;

FIG. 10 is a block diagram schematic view of a system that facilitates remote management of the dispenser position by the user device, according to another form of the invention;

FIGS. 11 and 12 illustrate various process flow diagrams depicting several possible communication protocols facilitating remote management of the dispenser position by the user device, in conjunction with the system of FIG. 10, according to the invention;

FIG. 13 is a block diagram schematic view of a single board dispenser architecture, according to another form of the invention; and

FIGS. 14 and 15 show block diagram views of further alternate forms of the invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

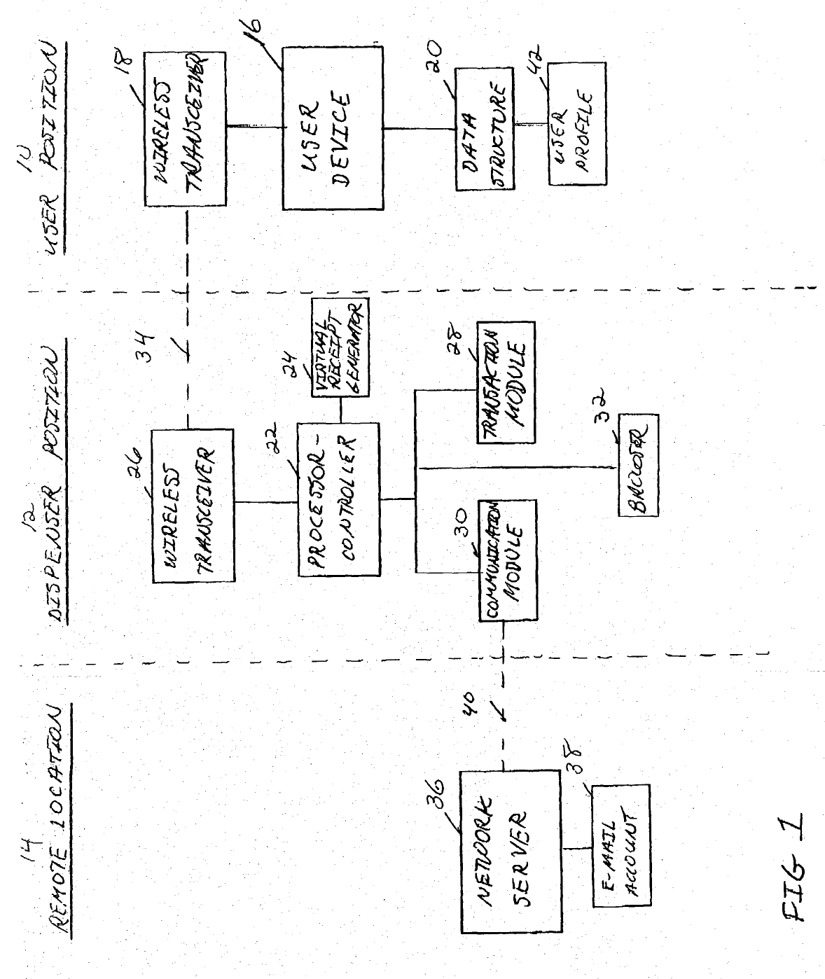

Referring now to the drawings and particularly to FIG. 1, there is shown a block diagram of a system involving components at a user position 10, dispenser position 12, and remote location 14, according to the invention.

The dispenser position 12 corresponds to the refueling location in conventional dispenser environments or fuel service stations where individual customers may service their vehicle, namely, conduct a refueling operation. Accordingly, though not shown, dispenser position 12 will also include all of the components found in conventional fuel dispenser configurations.

The user position 10 corresponds to the general location of a user device 16 associated with a refueling customer in connection with dispenser position 12. In particular, user device 16 is associated with a customer who undertakes a refueling transaction at dispenser position 12.

Generally, remote location 14 is broadly representative of locations apart from either the specific dispenser position 12 or user position 10. For example, remote location 14 may be a local position within the same dispenser station environment, such as a store, station operator terminal, or point-of-sale (POS) facility.

In brief, the illustrated system involves the generation of a virtual transaction receipt at dispenser position 12 and communication of the virtual receipt to user device 16 and/or a destination specified by user device 16, e.g., remote location 14.

Furthermore, the system depicted by FIG. 1 may be configured to operate in at-least two operating modes, namely, a user messaging mode and a remote messaging mode, in accordance with one form of the invention. In particular, when user device 16 implements a user messaging mode, the virtual transaction receipt-ticket generated at dispenser position 12 is issued by dispenser position 12 to user device 16. Alternately, when user device 16 implements a remote messaging mode, the virtual transaction receipt is forwarded by dispenser position 12 to a remote destination 14 specified by the customer via user device 16.

For example, the remote destination may be an e-mail account or server. In either case, user device 16 would furnish dispenser position 12 with destination information, e.g., an e-mail address or network server address. Both modes may also be implemented in the same communication session so that one version of the virtual transaction receipt is forwarded to user device 16, while another identical version is forwarded to the specified remote location 14.

The user device 16 may be configured to enable it to selectively perform one or both modes. More specifically, the user device will preferably be equipped to handle both modes, though the user will likely activate only one depending upon the circumstances of the refueling transaction, e.g., personal or work-related. It should be understood that other modes of operation may be deployed in user device 16, in addition to those discussed herein.

Referring again to FIG. 1, the illustrated user position 10 includes user device 16, wireless transceiver 18, and data structure 20. Preferably, these components are integrated together into a single functional unit, such as a Palm Pilot or mobile phone, although other suitable forms are possible. Wireless transceiver 18 is adapted to facilitate wireless communications with a communications functionality at dispenser position 12.

As discussed further, data structure 20 may be provided in any suitable form such as memory or storage and contains information for downloading to dispenser position 12. For example, data structure 20 may include user profile information including refueling transaction-related data, such as payment information and user-specified refueling parameter selections, e.g., fuel type, purchase amount, and fuel amount. Additionally, data structure 20 would include information specifying an indication of remote location 14, such as en e-mail account or network address.

The illustrated dispenser position 12 includes a processor and/or controller 22, a virtual transaction receipt generator 24, a wireless transceiver 26, a transaction module 28, a communication module 30, and a browser 32. In one form, several of the illustrated components of dispenser position 12 are typically found in dispenser terminals, but are adapted for use in practicing the invention.

Processor 22 may encompass the microprocessor, microcontroller, or computing device typically found in conventional dispenser terminals that handles, among other tasks, the refueling transaction processing, control, and management. In one typical scenario, processor 22 would provide all of the conventional functionality typically found in dispenser terminals in regards to the various transaction-related tasks.

For example, processor 22 would be able to control the dispensing operation in conventional manner by properly configuring the dispensing equipment according to input selections indicative of values for certain refueling parameters. For example, processor 22 could be connected to the fuel pump and flowmeter to control the amount of fuel that is dispensed.

Moreover, processor 22 would be able to direct a conventional payment authorization procedure such as verifying a suitable balance in a credit card account. For purposes of facilitating the transaction, transaction module 28 has been provided, which is representative of any functionality suitable for use in processing the transaction. For example, transaction module 28 could provide assistance to processor 22 in authorizing the proposed method of payment (e.g., dial-up request to banking institution) or facilitating alternate forms of payment, e.g., coupon, discount, or rewards program. Transaction module 28 could also include the user interface typically found in dispenser terminals where customers select the method of payment and submit credit card/debit card information, e.g., a card reader.

Additionally, processor 22 would compile the transaction-related data to provide a summary or record of the completed transaction. Collection of such data by processor 22 may occur in any conventional manner and is well known to those skilled in the art. As known, a printed receipt is typically issued by fuel dispensers following completion of the refueling transaction. However, in accordance with the invention, a virtual receipt is instead (or additionally) generated at dispenser position 12.

For this purpose, dispenser position 12 is shown to include virtual receipt generator 24. In one form, generator 24 may be a separate unit connected to processor 22, from which it receives the transaction-related information needed to generate a suitable receipt. Additionally, generator 24 may be program code executable by processor 22 that serves to generate a signal embodying the receipt-type transaction-related information. For example, the virtual transaction receipt may be provided as an electronic signal suitable for communication, e.g., over a wired medium or a wireless medium. Any conventional means may be used to adapt the virtual receipt to the intended transport medium (e.g., wired or wireless) or otherwise facilitate its communication to user position 10 and/or remote location 14.

Dispenser position 12 includes a wireless communications facility such as wireless transceiver 26. During operation, a wireless communications link 34 is established between dispenser position 12 and user position 10 via transceiver 26 and transceiver 18. Any conventional protocol and communication format can be used to establish, maintain, and utilize link 34.

Dispenser position 12 also includes a communication module 30 enabling dispenser position 12 to communicate with remote location 14. Communication module 30 should be understood as encompassing any means suitable for use in facilitating the transport of the virtual transaction receipt to remote location 14. For example, in network applications involving communication with the Internet or World Wide Web, communication module 30 would include a suitable conventional network interface and connection to the internet. For Internet applications, a conventional browser 32 is provided at dispenser position 12 that interacts with processor 22 in known manner to facilitate access to the internet or other network.

Remote location 14 includes network server 36 and e-mail account 38. However, this configuration of remote location 14 is merely representative and should not be considered in limitation of the invention. Remote location 14 can be configured in any manner, such as a fax machine receiving the virtual transaction receipt as a fax transmission. Moreover, network configurations other than the example depicted in FIG. 1 are possible, involving, for example, plural network-server combinations and plural messaging and/or e-mail account combinations. Additionally, remote location 14 can be configured as a mobile device that receives the virtual transaction receipt as a wireless transmission.

As discussed further, in one mode, the virtual transaction receipt generated at dispenser position 12 is adapted for communication to user position 10. In particular, the virtual transaction receipt is communicated to user device 16 via wireless transceiver 26 (at dispenser position 12), link 34, and wireless transceiver 18 (at user position 10).

In another mode, the virtual transaction receipt generated at dispenser position 12 is adapted for communication to remote location 14. In particular, the virtual transaction receipt is communicated to e-mail account 38 hosted by network server 36 via communication over link 40 between communication module 30 (at dispenser position 12) and network server 36 (at remote location 14). This remote messaging feature is facilitated by user device 16, which specifies the remote destination for the virtual receipt in a download communication over link 34. For example, the e-mail address corresponding to e-mail account 38 is downloaded from user device 16 to dispenser position 12 via link 34. In conventional manner, processor 22 uses the address indicator (e.g., e-mail address) to properly formulate an e-mail communication to network server 36 that embodies the virtual receipt, for example, as text within the body of the e-mail message or as an attachment.

Referring still to FIG. 1, user device 16 may be configured in any of various forms providing different levels of functionality. In particular, the architecture of the user device may be scaled according to the desired types of applications envisioned by the user. Generally, however, the user device has a simplified construction that accommodates a variety of applications.

For example, user device 16 can be configured in various forms to facilitate applications involving the user messaging mode, namely, communication of the virtual transaction receipt from dispenser position 12 to user position 10 (i.e., user device 16). In one form, user device 16 can be configured simply to establish communication with dispenser position 12 and to request that the virtual transaction receipt be issued to user device 16 over the established wireless communications link 34. In one such application, for example, the transaction-related and payment-related parameters could be submitted off-line (i.e., not from the user device), such as manual entry by a customer interacting with a display unit typical of conventional dispenser positions. It may be considered that this form of the input device is relatively low-level in terms of functionality and hardware/software requirements.

In another form, user device 16 can be configured to download a user profile 42 (embodied in data structure 20) to dispenser position 12 and to similarly request that the virtual transaction receipt be issued to user device 16 over the wireless communications link 34. This embodiment likewise is relatively low-level in the sense of requiring simple communication capabilities (i.e., transmit/receive); basic memory to store user profile information (e.g., payment data and transaction parameter selections); and a simple input interface (optional) to allow the user to submit additional user profile information (e.g., transaction parameters such as amount of fuel).

In a preferred form, the user profile 42 downloaded from user device 16 to dispenser position 12 offers the customer the opportunity to tailor the transaction experience to different levels of automation. For example, one user profile could contain all of the information needed by the dispenser to authorize, process, and conduct a refueling operation. Such a user profile would include, without limitation, refueling parameters (e.g., type of fuel) and payment/billing information (e.g., credit card number and banking institution contact data). If a standard amount of fuel is typically purchased, this purchase amount value can be embodied in the user profile as volume or total cost data. In one form, then, the user profile may constitute a record of permanent user data.

Thus, the user profile may be constructed as a fully defined and preexisting record that could be downloaded by a simple command, such as one-button activation of a predefined task or function key on the user device that serves to initiate wireless communications with the dispenser position and subsequently download the user profile. In this manner, no further input or interaction is needed by the customer vis-à-vis the dispenser, other than physically engaging the dispenser nozzle to the vehicle and dispensing the fuel.

Accordingly, when a user profile is available on the user device containing all of the refueling transaction parameters, a user can approach the dispenser and initiate an automatic refueling transaction by a single command instructing a download of the user profile to the dispenser position, which recognizes and processes the contents of the user profile and carries out the transaction according to the user profile data. For this purpose, it is apparent that processor 22 (at dispenser position 12) would be configured to receive and process the user profile information to thereby facilitate the transaction, in a conventional manner. Thus, the essential tasks of the refueling operation would be executed automatically, such as proper configuration of the dispenser equipment (via the preexisting refueling data parameters), payment authorization, and debiting/crediting.

In another form, any of the data elements comprising the contents of the user profile can be adjustable. For example, if the payment information is permanent, then the user profile can be adapted to the current refueling operation by enabling the user to set desired values for the refueling parameters, namely, type and amount of fuel to be dispensed. For this purpose, user device 16 could be equipped with any known means (e.g., user interface mechanism such as a keyboard or other input means) to facilitate user data input. In particular, this current data could be inputted into the user device by any of various input means known to those skilled in the art.

The input data would then be used to modify the user profile, namely, by supplementing it to include the selections for the current refueling operation. Thus, the user profile can be a combination of permanent and dynamically adjustable information. The subsequent dispenser operation, however, remains fully automated since the user profile contains all of the information needed to implement automated dispenser configuration, payment authorization, and billing activity.

Additionally, user device 16 can be configured in various forms to facilitate applications involving the remote messaging mode, namely, communication of the virtual transaction receipt from dispenser position 12 to remote location 14 (e.g., e-mail account 38). In one form, the user device can be configured simply to download to the dispenser position a destination address (e.g., a network address, URL or e-mail address) specifying where the dispenser is to send the virtual transaction receipt.

In one such application, for example, the transaction-related and payment-related parameters could be submitted offline (i.e., not from the user device), such as manual entry by a customer interacting with a display unit typical of conventional dispenser positions.

In another form, the user device can be configured to download a user profile 42 to the dispenser position, similar to the one discussed above. The user profile would preferably include a destination indicator (e.g., network address, server URL, or e-mail address) specifying where the dispenser is to send the virtual receipt. For example, the user profile could include an e-mail address or other electronic messaging address. This embodiment likewise is relatively low-level in the sense of requiring simple communication capabilities (i.e., transmit/receive); basic memory to store user profile information (e.g., payment data, transaction parameter selections, and server address); and a simple input interface (optional) to allow the user to submit additional user profile information (e.g., transaction parameters such as amount of fuel).

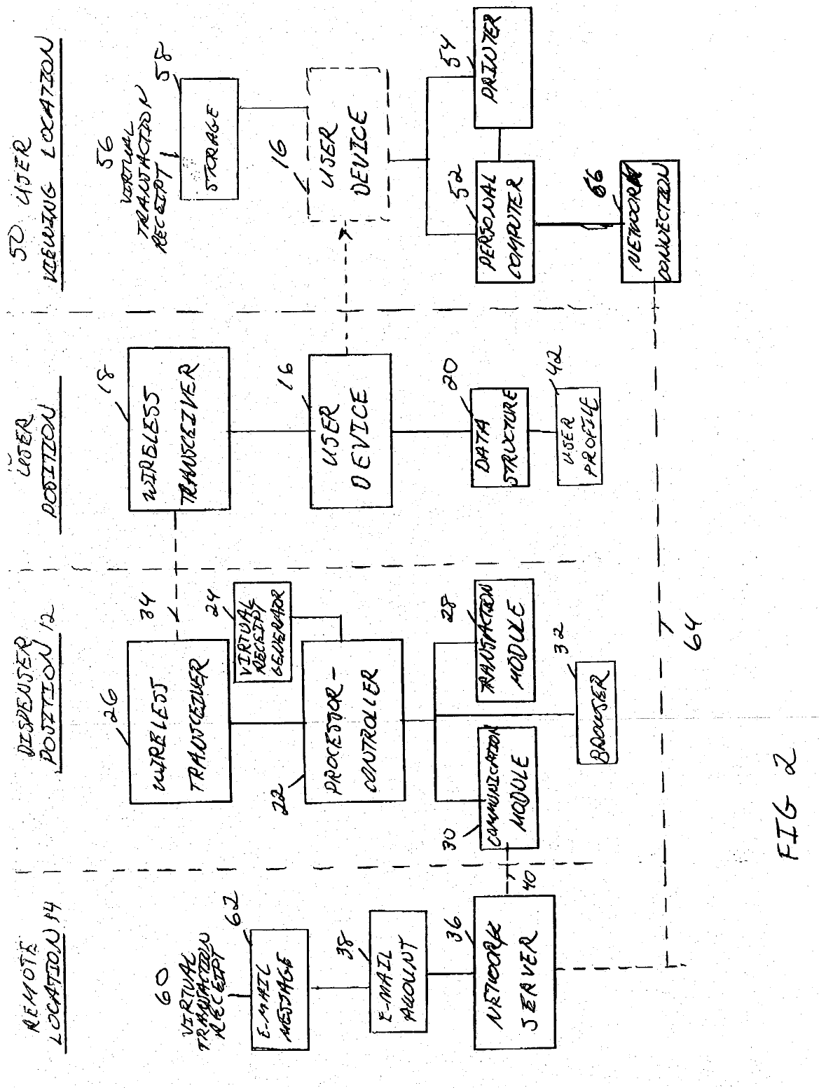

Referring now to FIG. 2, there is shown a block diagram of a system similar to FIG. 1, but supplemented with a user viewing location 50 to illustrate several possible applications of the invention.

The user viewing location 50 may be broadly considered to encompass any facility where the user can access and/or retrieve the transmitted virtual transaction receipt. For example, location 50 could be a home or business office equipped with a personal computer 52, printer 54, and network connection 66.

In the operating mode where the virtual transaction receipt 56 is communicated to and stored on user device 16 (e.g., in memory storage 56), the user device 16 would be present in user viewing location 50 (as shown in phantom). In conventional manner, the virtual receipt 56 could be accessed and viewed in several different ways.

For example, the virtual receipt 56 could be downloaded for printing over a wireless link to printer 54 having a wireless communication facility. Additionally, suitable communication could be established between user device 16 and personal computer 52 so that virtual receipt 56 could be downloaded to PC 52 and opened. PC 52 could then direct a wired/wireless peripheral printer such as printer 54 to make a hard-copy of the virtual receipt. It should be apparent that any mechanism may be used to access and retrieve virtual receipt 56 from user device 16.

In the operating mode where the virtual transaction receipt 60 is communicated to remote location 14 in conjunction with an e-mail message 62, for example, the virtual receipt 60 could be accessed and viewed in several different ways.

For example, at user viewing location 50, PC 52 having a network interface (i.e., browser) and a conventional network connection 66 can access the relevant e-mail account 38 via a link 64 with associated network server 36, in a manner known to those skilled in the art. In conventional manner, then, a user can employ PC 52 to access and retrieve e-mail message 62 and the virtual transaction receipt 60 associated therewith.

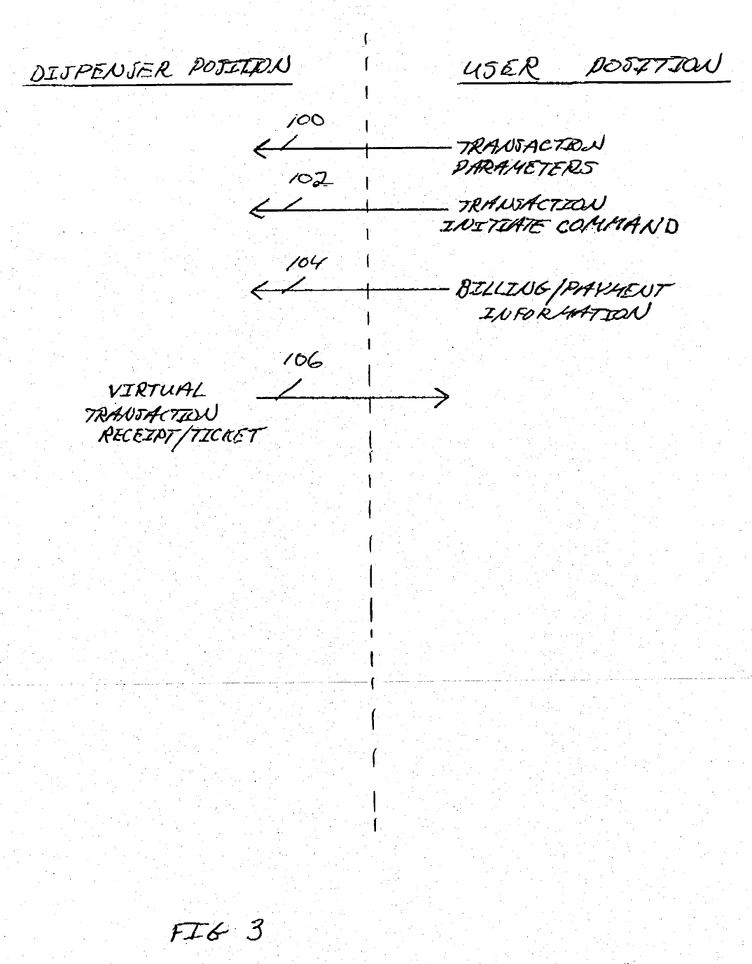

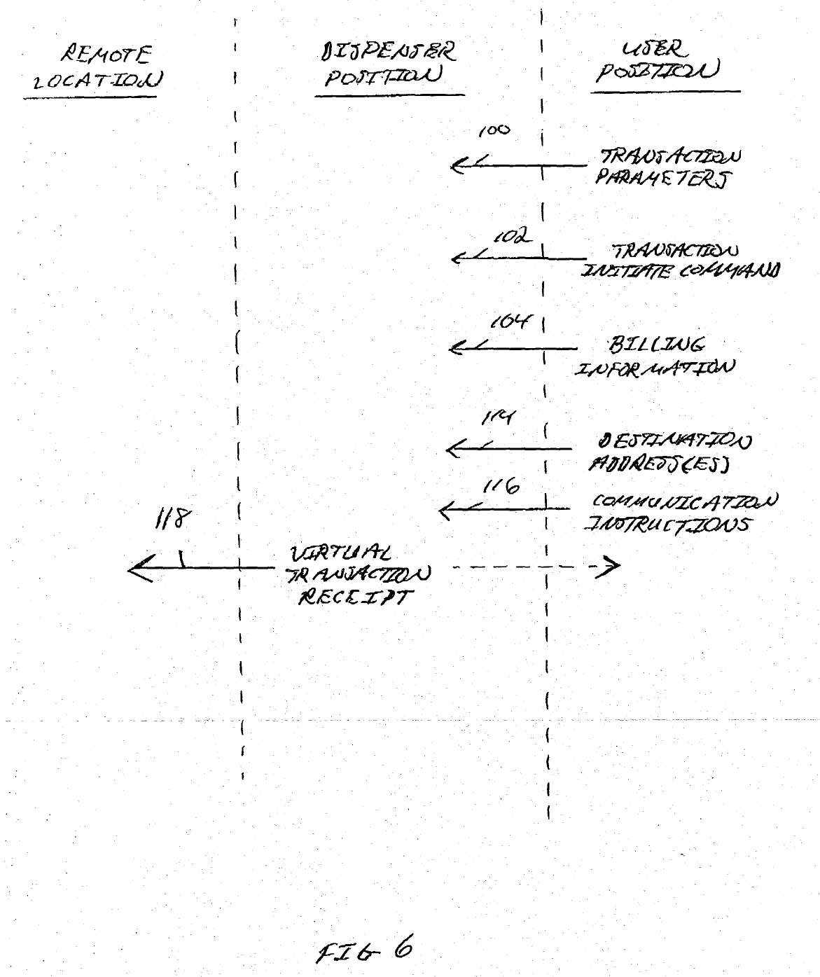

Referring now to FIGS. 3-8, there are shown various process flow diagrams depicting various illustrative operating sequences for practicing the invention, in conjunction with the system of FIG. 1. FIGS. 3-5 relate to the user messaging mode involving communication of the virtual transaction receipt from the dispenser position to the user device. FIGS. 6-8 relate to the remote messaging mode involving communication of the virtual transaction receipt from the dispenser position to the remote location.

Referring to FIG. 3, the illustrated operating sequence comprises operations 100, 102 and 104 respectively involving the user device communicating to the dispenser position refueling transaction parameter selections, a refueling operation transaction initiate command, and billing/payment information. Preferably, in order to facilitate an automated and expedited transaction feature, the information embodied in operations 100, 102 and 104 is contained within a common user profile and simultaneously transmitted to the dispenser position.

At the dispenser position, the refueling transaction is executed. In particular, the refueling equipment is configured according to the transaction parameter selections communicated from the user device, and billing/payment is finalized according to the billing/payment information communicated from the user device. Once the transaction is completed, operation 106 is executed in order to transmit the generated virtual transaction receipt to the user device at the user position.

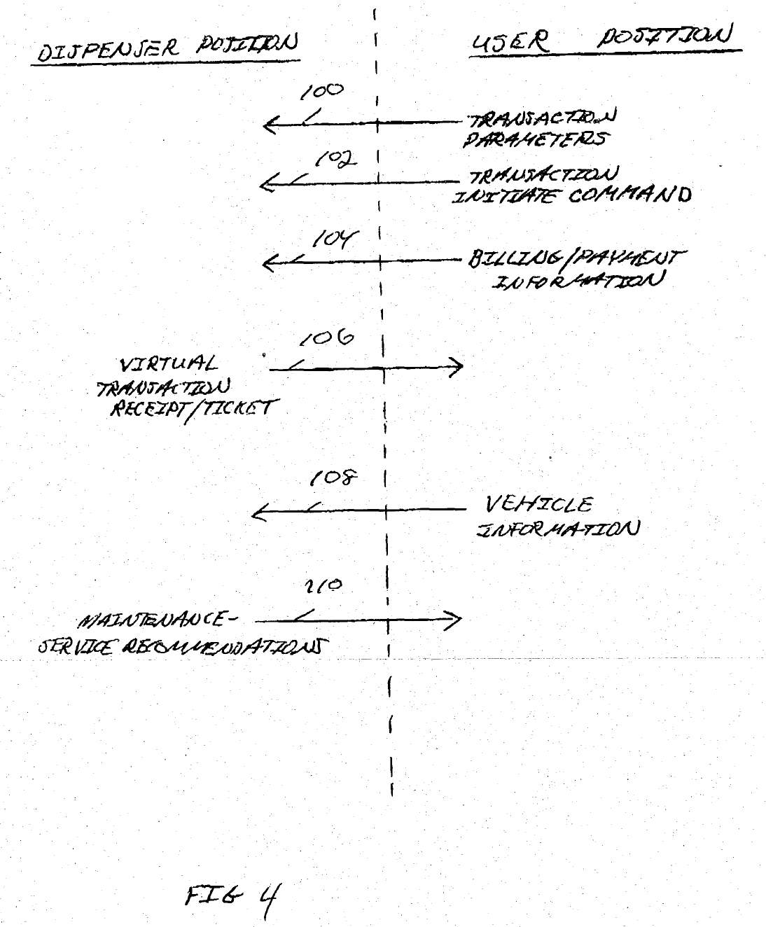

Referring to FIG. 4, the illustrated operating sequence includes the operating sequence shown in FIG. 3, but further comprises operation 108 involving communication of customer vehicle information from the user device to the dispenser position, and operation 110 involving communication of maintenance-service recommendations from the dispenser position to the user device.

As an enhancement, the user device furnishes the dispenser position with vehicle information that is analyzed and processed to determine any vehicle servicing or maintenance recommendations based upon the vehicle information analysis. For example, the vehicle information can include, but is not limited to, mileage, vehicle year/make/model, and repair history. The vehicle information can be furnished to the dispenser position in a user profile that also includes the information pertaining to operations 100, 102, and 104. For purposes of performing the analysis, the dispenser position will be equipped with any suitable maintenance and service analysis/evaluation units, such as conventional forms.

The service and/or maintenance recommendations formulated by the dispenser position based upon the submitted vehicle information may be transmitted to the user device in a communication separate from the transaction-related virtual receipt. However, the recommendations are preferably contained within the virtual transaction receipt.

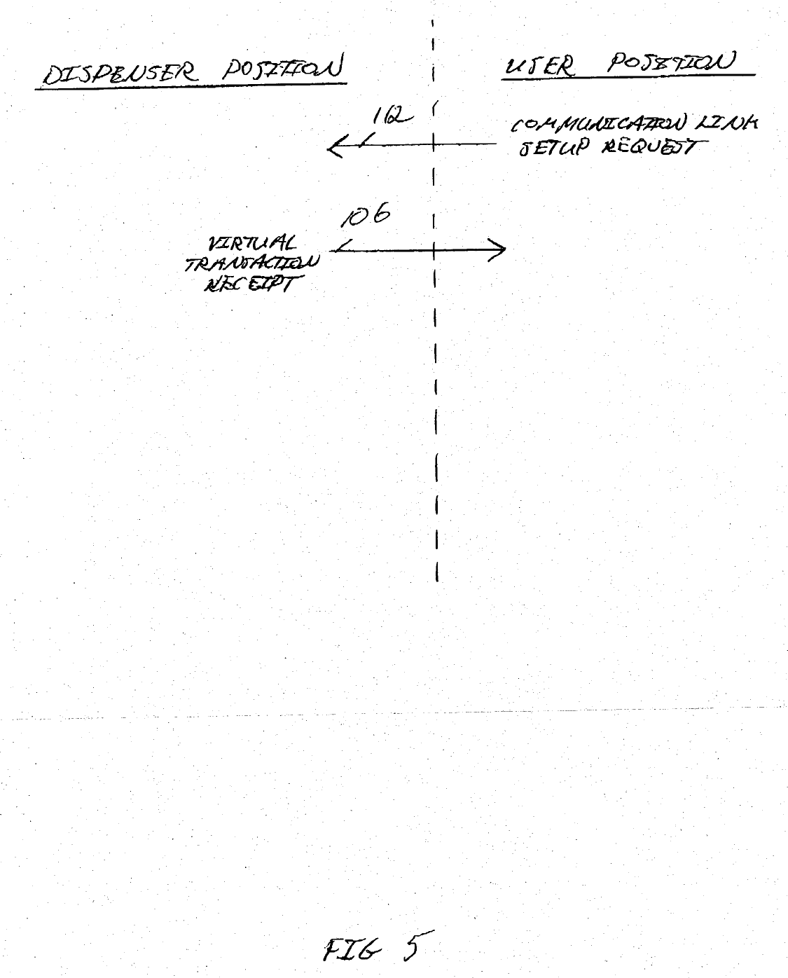

Referring to FIG. 5, the illustrated operating sequence is a simplified protocol comprising operation 112, which involves the user device communicating with the dispenser position to establish a wireless link therewith and thereby to notify the dispenser position of the presence of the user device vis-a-vis receiving a virtual receipt. As shown, the user position would not be communicating transaction-related information to the dispenser position. In particular, the protocol of FIG. 5 facilitates receipt of a virtual transaction receipt when the customer manually makes the refueling parameter selections and personally activates the payment module, e.g., swiping a credit card through the dispenser card reader. As shown, following the transaction, a virtual receipt is forwarded to the user position.

FIGS. 6-8 represent protocols facilitating transfer of the virtual transaction receipt to a remote location, according to various forms of the invention.

Referring to FIG. 6, the illustrated operating sequence comprises operation 114 involving the user device communicating a receipt destination indicator (i.e., destination address(es)) to the dispenser position, and operation 116 involving the user device communicating instructions to the dispenser position instructing the dispenser position to transmit the virtual transaction receipt to the remote location specified by the accompanying destination address. In a preferred form, the information pertaining to operations 114 and 116 will be embodied in the user profile containing the information pertaining to operations 100, 102 and 104.

Following completion of the refueling transaction, the virtual transaction receipt generated by the fuel dispenser is communicated (in operation 118) to the remote location pursuant to the destination address, e.g., e-mail account address. Notably, the virtual receipt can be transmitted to multiple remote locations corresponding to multiple e-mail addresses. Optionally, the virtual receipt can also be forwarded to the user device as above.

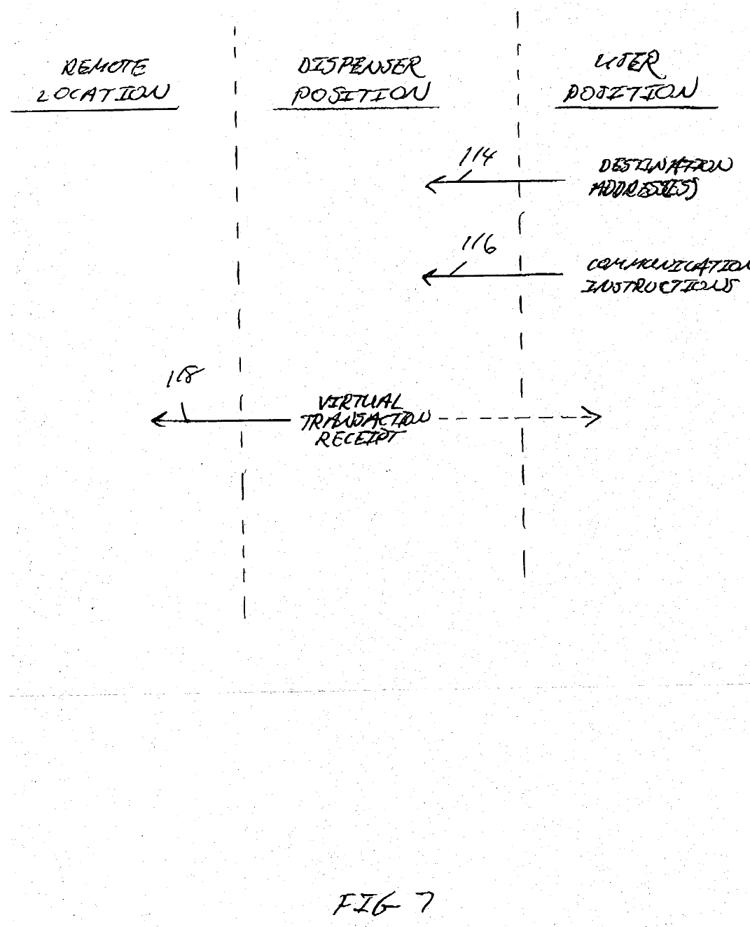

Referring to FIG. 7, the illustrated operating sequence is a simplified protocol comprising operations 114 and 116 discussed above. As shown, the user position would not be communicating transaction-related information to the dispenser position. In this respect, at least, this protocol resembles the protocol illustrated in FIG. 5. In particular, the protocol of FIG. 7 facilitates communication of a virtual transaction receipt when the customer manually makes the refueling parameter selections and personally activates the payment module, e.g., swiping a credit card through the dispenser card reader. As shown, following the transaction, a virtual receipt is forwarded to the remote location.

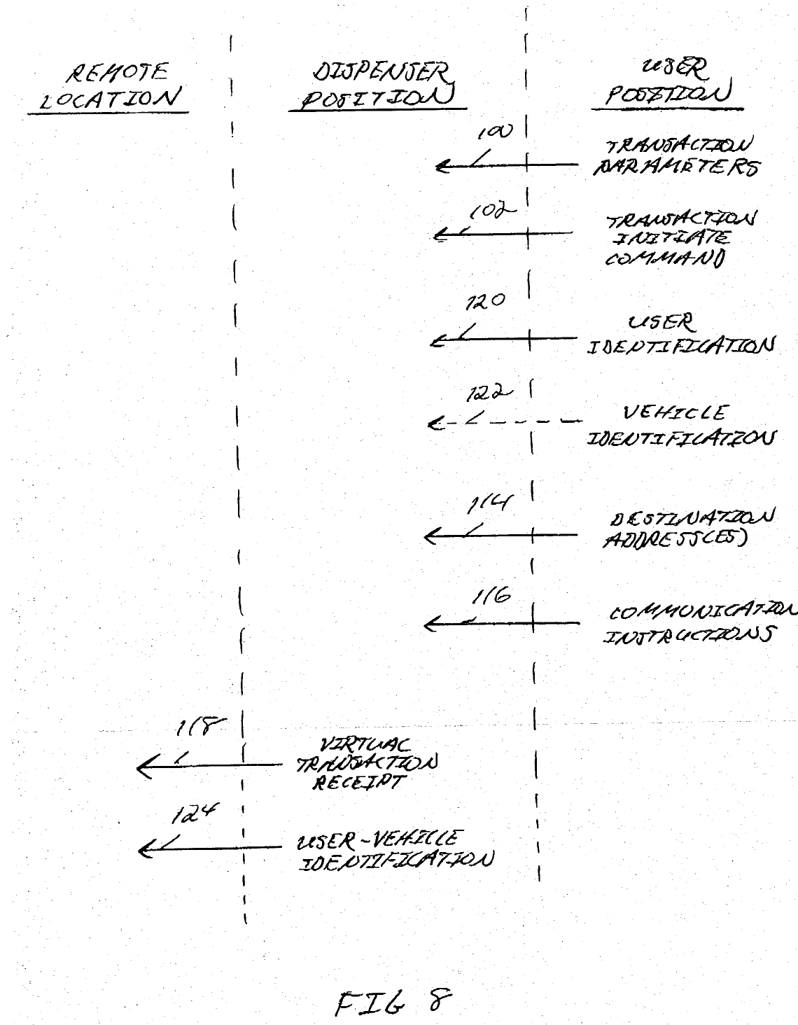

Referring to FIG. 8, the illustrated operating sequence includes operations 100, 102, 114 and 116 as above, but further comprises operations 120 and/or 122 that respectively involve the user device communicating user identification information and vehicle identification information to the dispenser position. This protocol finds use in applications where it is desired to facilitate a centralized billing process or manage and/or track the expenditures involving plural refueling customers and/or vehicles.

For example, in a fleet management system, it would be advantageous to receive a virtual receipt correlated to the driver and/or vehicle every time the vehicle was refueled. Additionally, in an employer-type expense report management system, it would be advantageous to receive a virtual receipt correlated to the refueling customer.

Referring again to FIG. 8, the user device communicates (in operations 120 and 122) user ID data and/or vehicle ID data for purposes of association or correlation with the virtual transaction receipt. Although the information pertaining to operations 120 and 122 may be forwarded to the dispenser position in a separate communication, it preferably will be contained within the user profile containing the information pertaining to operations 100, 102, 114 and 116, as above.

As shown, the dispenser position executes operation 124 to communicate the user-vehicle identification information (received from the user device) to the remote location. Preferably, the information pertaining to operation 124 will be contained within the virtual transaction receipt or in the same communication as the virtual transaction receipt, e.g., the same e-mail message. The processor at the dispenser position can be readily configured to enable the user-vehicle ID information to be incorporated into the virtual receipt or same e-mail communication. In this manner, the transaction embodied in the virtual transaction receipt is associated with the particular customer and/or vehicle responsible for the refueling transaction.

A notable feature of the FIG. 8 protocol is the optional absence of billing or payment information issuing from the user device to the dispenser position. In particular, in a fleet management scheme or employer-based payment plan, payment may be directed to a central billing authority, e.g., fleet operator or employer. For this purpose, the virtual receipt may also contain or be accompanied by an invoice requesting payment. To this end, the user device may be configured to issue pertinent information to the fuel dispenser to enable a suitable invoice to be electronically prepared, such as identification of the fleet operator or employer. Otherwise, if payment is made by the fleet personnel or employee concurrent with the transaction, the FIG. 8 protocol can still be used to report the transaction to the appropriate entity in the form of the virtual receipt. For this purpose, the protocol could be modified to enable the user device to issue payment information to the dispenser position, as above.

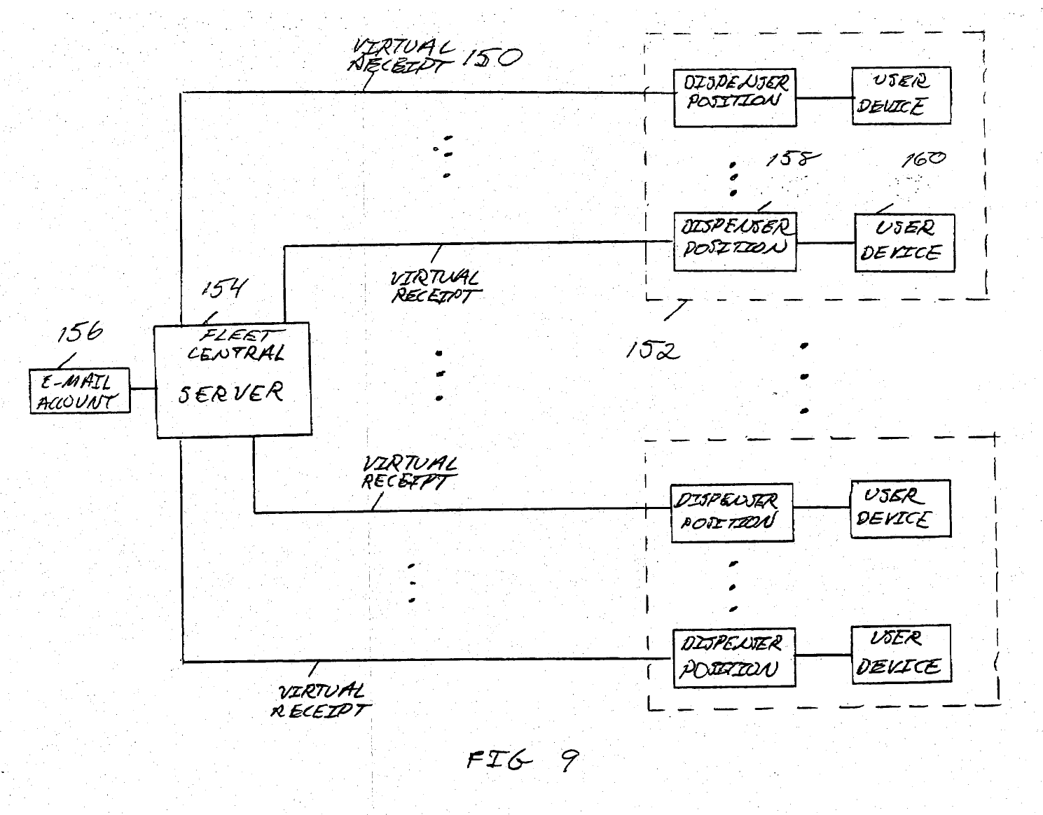

Referring to FIG. 9, there is shown a block diagram of a system for practicing the operational protocol of FIG. 8. As shown, virtual receipts 150 from a plurality of dispenser environments 152 can be centrally received and managed at a fleet central server 154, for example. As shown, each dispenser environment 152 includes plural dispenser positions 158 each adapted for communication with a respective user device 160 (similar to above with units 12 and 16), if so configured. The virtual receipts 150 may be loaded into an e-mail account 156 hosted by server 154.

Any of various forms can be used to submit the virtual receipts 150 to the fleet entity. For example, all of the virtual receipts 150 can be sent to a single e-mail address such as the financial department. Additionally, the virtual receipts 150 can be sent to various network subaddress locations grouped under a common main address location, in order to segregate the virtual receipts according to common business unit or other suitable destination assignment criteria, for example. It should be apparent that any addressing scheme can be used to facilitate communication of the plural virtual receipts 150 to the fleet environment.

It should be understood that the order in which the operations appear in the flow diagrams herein are merely illustrative and should not be considered in limitation of the invention, as other operation sequences are possible within the scope of the invention that achieve similar functionality.

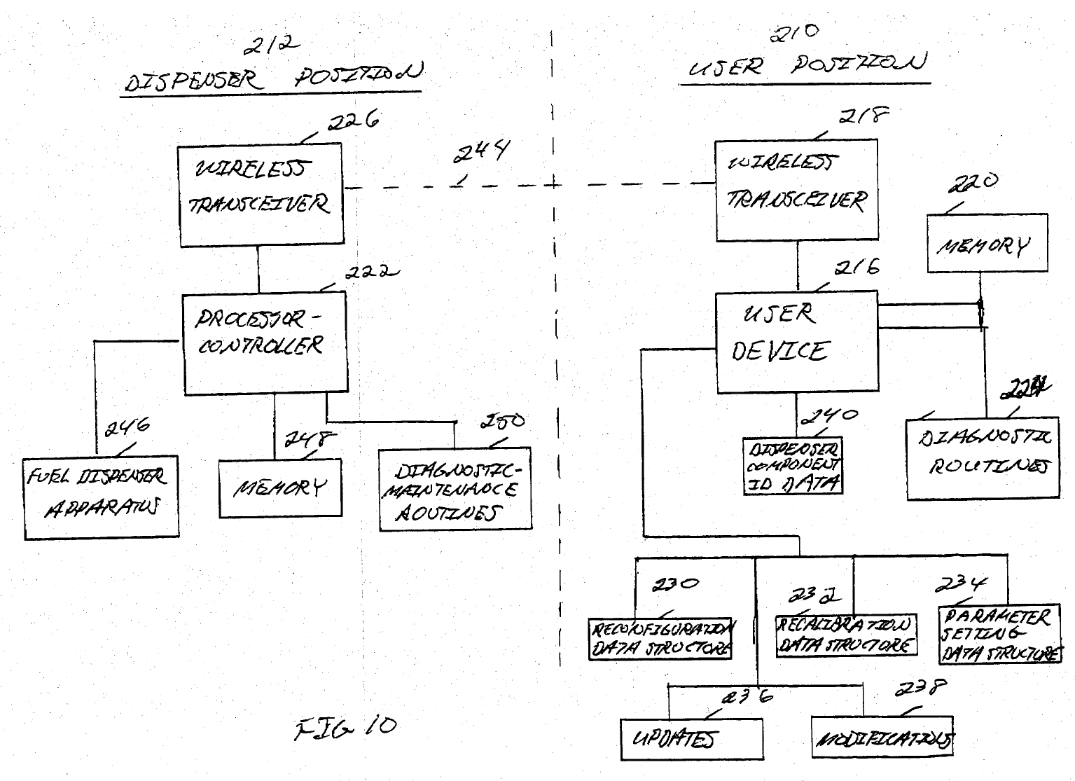

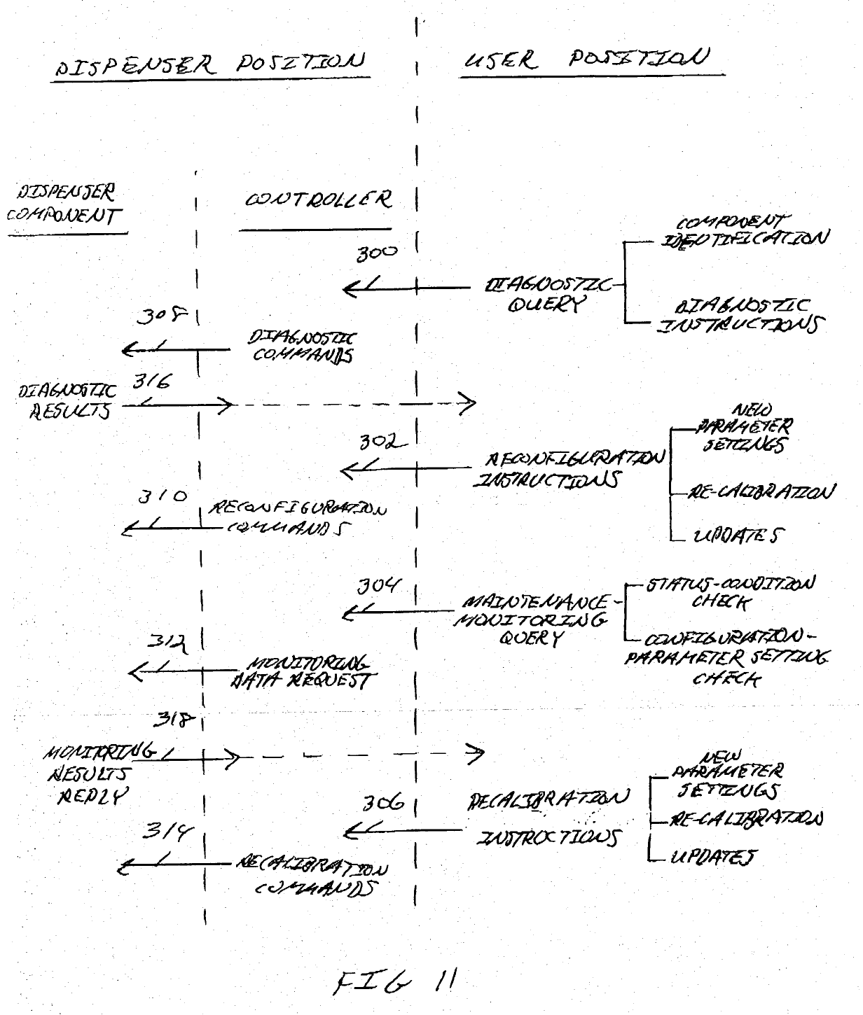

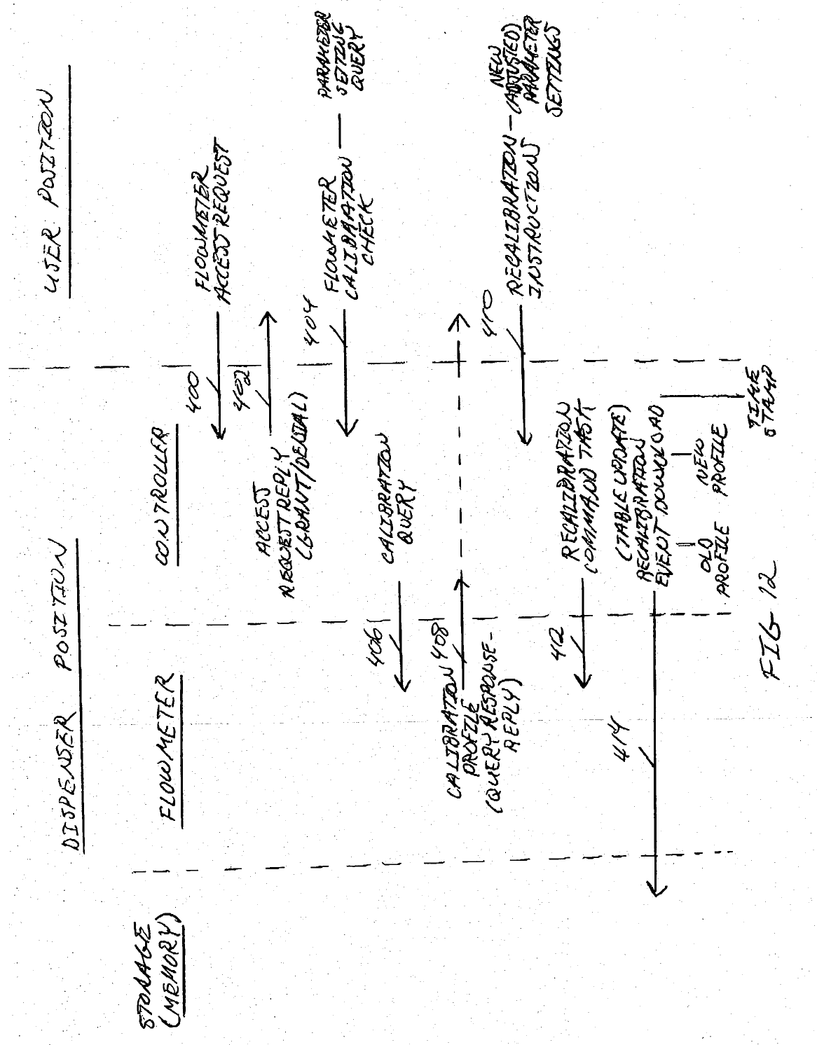

Referring now to FIG. 10, there is shown a block diagram of a system for use in remotely managing the dispenser position 212 from a user device 216 at the user position 210, according to another form of the invention. FIGS. 11 and 12 depict process flow diagrams illustrating respective operational protocols for use in conjunction with the system of FIG. 10. FIG. 12 specifically represents a protocol directed to the execution of a calibration function relative to the dispenser flowmeter assembly.

By way of overview, FIG. 10 depicts a system enabling a user device to remotely direct various management functions involving the fuel dispenser position. These management functions include, but are not limited to, diagnostics, maintenance, reconfiguration, recalibration, updates, modifications, and monitoring. For this purpose, both user device 216 and dispenser position 212 would be suitably configured to facilitate execution of the management functions. For example, user device 216 may be equipped in memory with various executable program code structures that embody routines to perform the management functions. Dispenser position 212 could be similarly configured, as needed.

Referring to FIG. 10, user device 216 is generally configured to facilitate remote management of dispenser position 212 by user device 216. For example, user device 216 can be configured to direct, conduct, or otherwise facilitate a diagnostic operation and/or a parameter reconfiguration operation involving selectable dispenser components at dispenser position 212. The dispenser components targeted for management (e.g., diagnosis or reconfiguration) can be selectively specified by user device 216 using dispenser component identification data 240, such as a table denominating each addressable component and its corresponding access address or identifier.

In one form, user position 210 includes user device 216 having wireless transceiver 218, memory 220 including dispenser management-related functionalities such as diagnostic routines 224, and a data structure assembly including reconfiguration data structure 230, recalibration data structure 232, parameter setting data structure 234, updates 236, and modifications 238. These data structures contain data values for use in carrying out the specified management functions.

User device 216 and wireless transceiver 218 may be provided in a form comparable to components 16 and 18, discussed above in FIG. 1. In integrated form, the functionalities of the relevant user device described in FIGS. 1-12 can be combined and made available on the same user device platform. A user could then select among the different operational modes, namely, to receive a virtual transaction receipt, to direct communication of a virtual transaction receipt to a specified address, and/or to facilitate the execution of dispenser management functions.

In one form, dispenser position 212 includes processor-controller 222, wireless transceiver 226, fuel dispenser apparatus 246, memory 248, and diagnostic-maintenance routines 250 representative of management-related functionalities. As before, a communications link 244 connects dispenser position 212 and user position 210 (via transceivers 226 and 218). Processor 222, wireless transceiver 226, and link 244 may be provided in a form comparable to components 22, 26 and 34, discussed above in FIG. 1. Apparatus 246 includes the arrangement of dispenser components typically found in conventional dispenser terminals.

Referring now to FIG. 11 (in conjunction with FIG. 10), there is shown a process flow diagram illustrating an operating protocol that enables the user device 216 to conduct various illustrative remote management functions on dispenser position 212, specifically in regard to the components of dispenser apparatus 246.

The illustrated protocol comprises operations 300, 302, 304 and 306 respectively involving user device 216 communicating to dispenser position 212 a diagnostic query, reconfiguration instructions, maintenance-monitoring query, and recalibration instructions. In response, the dispenser position (e.g., controller) performs operations 308, 310, 312, and 314 to generate and issue the appropriate management commands to the specified components, namely, diagnostic commands, reconfiguration commands, monitoring data request, and recalibration commands, respectively. This command structure facilitates execution of the specified management function, in a manner known to those skilled in the art. Furthermore, in response, the affected dispenser components may return diagnostic results (operation 316) and monitoring results (operation 318), which may be forwarded to the user device.

Referring now to FIG. 12 (in conjunction with FIG. 10), there is shown a process flow diagram illustrating an operating protocol that enables the user device 216 to recalibrate the flowmeters. This protocol is particularly effective when the flowmeters are electronically-accessible so that the device can be remotely accessed, thereby avoiding physical intrusion into the dispenser cabinet and the need to break the flowmeter seal, which otherwise occurs in conventional maintenance schemes.

The protocol includes operation 400 involving the user position requesting flowmeter access, and operation 402 involving the dispenser position communicating the access request decision to the user device, i.e., grant or denial. Any security scheme may be used to protect access to the flowmeters, such as coding or key encryption. In order to ascertain the current calibration condition, the user position issues a flowmeter calibration check (operation 404), and, in response, the controller issues a calibration query to the flowmeter (operation 406). The flowmeter returns a calibration profile indicating the current calibration values (operation 408), which may be issued to the user device for evaluation.

In order to facilitate recalibration, the user device issues recalibration instructions to the dispenser controller (operation 410) indicating the new or adjusted calibration settings. In response, the dispenser controller issues the appropriate recalibration commands (operation 412) to effectuate the specified recalibration. Preferably, whenever a recalibration event occurs, the old and new calibration profile are downloaded and stored in memory 248 of the dispenser position (operation 414). Accordingly, memory 248 (FIG. 10) maintains a historical record of the calibration changes so that future recalibration events can perhaps restore a prior recalibration profile or to track the changes in order to detect repeated or trending failure in the flowmeter.

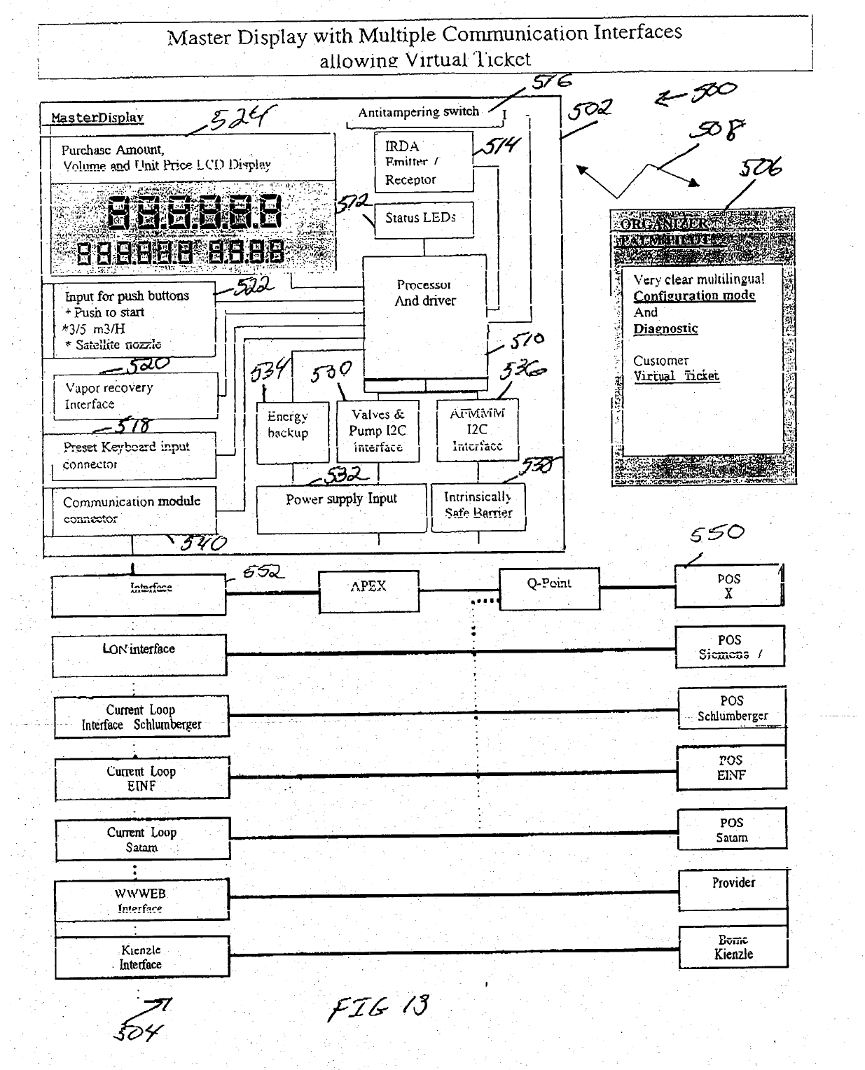

Referring now to FIG. 13, there is shown a block diagram depicting a single board, integrated design scheme in which the various control, processing, management, and interface functionalities of the fuel dispenser position have been consolidated onto a single board assembly (e.g., printed circuit board). The single board construction has been adapted with suitable interface mechanisms to enable transparent connection to the dispenser peripheral components and to various local loops and networks associated with multiple vendors. In one form, the single board assembly can be constituted as a master display with multiple communication interfaces, and which preferably allows virtual transaction ticket generation and communication in a manner similar to that discussed above.

As shown, the illustrated fuel dispenser environment 500 includes a single board assembly 502 at a respective fuel dispenser position, an array of networks (e.g., POS terminals) depicted generally and representatively at 504, a user device 506 operably associated with the fuel dispenser position, and a wireless link 508 between the single board assembly 502 and user device 506. The construction and functionality of user device 506 and its wireless connection to the fuel dispenser position is comparable to that shown and described in FIG. 1 relative to user position 10 and dispenser position 12. The dispenser positions 12 previously discussed can be implemented according to the single board design shown in FIG. 13, without departing from the scope of the invention.

In combination, assembly 502 includes a processor and driver 510; status LEDs 512; an IRDA communications interface 514 (e.g., an emitter/receptor such as a wireless transceiver) configured for wireless communication with user device 506 (e.g., an organizer or Palm Pilot); an anti-tampering switch 516 for standalone mode purposes; a preset keyboard input connector 518 (e.g., 4*4 keys); a vapor recovery interface 520 configured to communicate with the vapor recovery equipment and to deliver pulses according to the volume displayed; module 522 providing extra push-button inputs for push to start and ⅗ m3/H selections, and a satellite nozzle; and a display panel 524 having the indicated illustrative form to display transaction-related information.

Assembly 502 also includes an I2C interface 530 to facilitate communication with the off-board valves and fuel pump; an interface 532 to the power supply input; an energy backup 534; and an I2C interface 536 to facilitate communication with the off-board Axial Flow Meter Modules (AFMMM) on a daisy chain through an on-board intrinsically safe barrier 538.

Assembly 502 further includes a communication module interface 540 adapted to enable connectivity and communication with any of the units in system 504. For example, on-board interface 540 facilitates communication with representative POS terminal or facility 550 by suitable connectivity to its respective interface 552. For this purpose, on-board interface 540 will be configured to recognize the communication format and protocol needed to connect and “talk” to POS 550. Interface 540 will then permit transparent communications between assembly 502 and POS 550. Interface 540 will include any suitable means needed to transform or otherwise translate on-board signals into the communication format compatible with the desired POS link.

The integration of the indicated assembly units into the single board assembly can use techniques known and readily available to those skilled in the art.

Regarding network arrangement 504, the single board assembly is capable of presenting multiple communication interfaces each adapted to establish communication with a particular arrangement. For example, one arrangement affiliated with Tokheim Corporation involves the APEX POS and Q-Point controller for interfacing with APEX. Additionally, as shown, the present invention can be utilized, in part, with a Siemens POS which utilizes a LON interface; a Schlumberger POS which utilizes a current loop interface; an EINF POS which utilizes a current loop interface; a Satam POS which utilizes a current loop interface; a Borne Kienzle POS which utilizes a Kienzle interface; and the internet, as described above. This vendor list is not exhaustive but merely illustrative and should not be considered in limitation of the invention.

A preferred implementation of the invention utilizes wireless communications between the user device and dispenser position, which is advantageous because it eliminates the need for any physical hook-ups or connections. In the invention, by employing well-known handshaking and other suitable wireless communication protocols, a communication link can easily be established between the user device and dispenser position. However, if a physical connection must be made such as with a user laptop, the dispenser position can be readily adapted to include an interface port that receives the standard output cabling from the laptop. In this form, well-known connectivity mechanisms and protocols are used to facilitate a plug-and-play capability involving the laptop and dispenser position. For example, the laptop could be connected to the communications bus of the dispenser so that, in effect, the laptop becomes a peripheral component.

It should also be apparent that the remote site or location 14 may be configured in any physical or logical form, such as implementations in hardware, software, firmware, logic circuits, or any combination thereof. For example, remote location 14 may include a mobile device, network machine, server, computer (e.g., PC), and PDA. Accordingly, the invention should be understood as enabling communication of the virtual transaction receipt to a destination (remote location 14) embodied in any form.

Additionally, any means of communication may be used to establish a connection between the relevant dispenser position and remote site, such as a wired or wireless link, e.g., RF transmissions, cabling, digital and/or analog communications, cellular and/or mobile networks, satellite, any electromagnetic spectrum communication, optical communication, internet-access, dial-up access, and land-based communications (e.g., POTS).

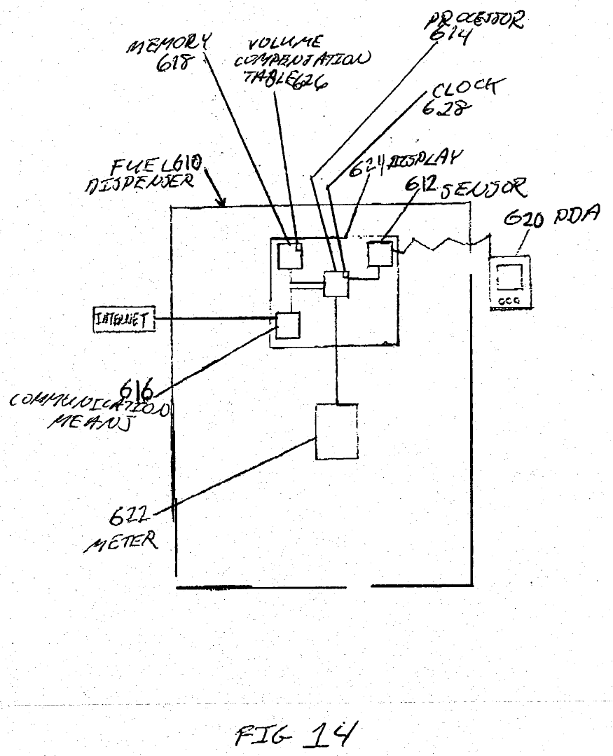

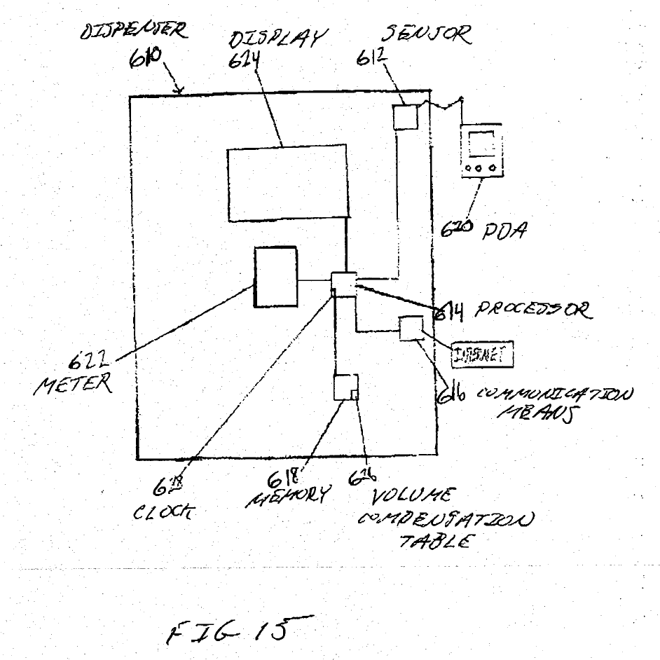

Referring to FIGS. 14 and 15, there are shown further alternate forms of the invention.

Referring to FIG. 14, a fuel dispenser 610 has a display 624 and a meter 622. Although this arrangement is described in connection with a fuel dispenser, it may encompass any device that is utilized to conduct a transaction such as an Automated Teller Machine (ATM) or a phone. Other types of devices utilized to conduct transactions can be used as well. Display 624 has a sensor 612, a processor 614, a communication means 616 and a memory 618. Processor 614 is connected to sensor 612, connection means 616, memory 618 and meter 622 utilizing cables or some other connection device. Sensor 612 is activated utilizing a wireless device wherein the wireless device is a Personal Digital Assistant (PDA) 620. PDA 620 includes, but is not limited to, PALM PDAs, the Pocket PC, HANDSPRING VISOR PDAs and digital cellular phones.

PDA 620, sensor 612 and processor 614 utilize the Infrared Data Association (IrDA) Standard to wirelessly transfer data between PDA 620 and processor 614. Wireless communication between PDA 620, processor 614 and sensor 612 is not limited to infrared light beams and therefore, radio frequency waves, microwaves, receiver signal power communication devices and other data transmission mechanisms and methods can be used.

This embodiment utilizes a software program to allow fuel dispenser 610 to communicate with PDA 620. The software program can be written on a computer, such as an IBM compatible with at least a 300 MHZ processor. Other computers can be used as well. The software program is written in a database programming language such as Visual Basic. Other database programming languages can be used as well. The software, which is utilized by PDA 620, stores information the customer would like to have included in their customer information utilized by the present invention. The software allows fuel dispenser 610 to retrieve the customer information stored on PDA 620. Once the customer information is retrieved from PDA 620, fuel dispenser 610 utilizes the information for many purposes that will be described herein.

One benefit the software provides is converting measurement information between the Metric System and the English System. The software also instructs fuel dispenser 610 to transmit an electronic ticket detailing the transaction to at least one location as listed in the customer information stored on PDA 620.

Upon completion of a fueling transaction, PDA 620 transmits an infrared beam to sensor 612 to activate sensor 612. PDA 620 can transmit the infrared beam to sensor 612 to activate sensor 612 at any time during the fueling transaction and is not limited to the completion of the fueling transaction. Sensor 612 activates processor 614 and processor 614 retrieves the volume of fuel dispensed during the transaction from meter 622. Processor 614 calculates the cost of the fuel based on the volume retrieved from meter 622. Processor 614 transmits the volume of fuel dispensed, the date, the time, the location of the fuel dispenser and the total cost of the fuel dispensed as an electronic ticket to PDA 620.

As already described, the software can convert the measurement information listed on the electronic ticket from the Metric System to the English System or the English System to the Metric System. This conversion is helpful when the customer only understands one of the systems and therefore the customer can convert the information into the system understood by the customer.

An electronic ticket includes receipts that describe the amount spent for goods and/or services, an itemized list of the goods and/or services purchased, the date of purchase, the time of purchase, and any other information relevant to the transaction. Also, the electronic tickets are utilized for transactions such as when clothing is donated to a charity and there is a receipt for a tax writeoff for the estimated cost of the clothing. The electronic ticket can contain detail regarding any aspect of a transaction that would be useful to the customer and the owner of the transaction device.

At approximately the same time as the electronic ticket is transmitted to PDA 620, processor 614 can communicate with PDA 620 to retrieve customer information from PDA 620. Customer information stored on PDA 620 can include, but is not limited to, the customer's name, the type of vehicle driven by the customer, the mileage on the vehicle, at least one e-mail address where the electronic ticket will be transmitted at the completion of a transaction and other types of information as well such as a credit card number and a phone card number.

After retrieving the customer information, processor 614 stores the information to memory 618. One of the reasons the information is stored to memory 618 is that discounts, such as coupons, can be transmitted to the customer if the customer purchases over a predetermined amount of fuel in a single transaction or the customer purchases fuel a predetermined number of times per week or month. Other parameters for providing discounts can be used as well. These discounts will be utilized to reward loyal customers.

The mileage and make of the vehicle are utilized by processor 614 to provide recommendations to the customer for oil changes or preventative maintenance once the mileage and make of the vehicle are compared to the manufacturer's suggested service schedule. The recommendations are transmitted as part of the electronic ticket.

In another form of the present invention, upon completion of the fueling transaction, processor 614 activates sensor 612 and sensor 612 sends an infrared beam to PDA 620. PDA 620 can transmit the infrared beam to sensor 612 to activate sensor 612 at any time during the fueling transaction and is not limited to the completion of the fueling transaction. Once a connection is made between processor 614 and PDA 620, processor 614 retrieves the customer information from PDA 620 and transmits an electronic ticket to PDA 620 and any other location specified in the customer information.

The customer utilizing PDA 620 can store one or more e-mail addresses in the customer information stored on PDA 620. The use of the e-mail addresses allows processor 614 to transmit the electronic ticket to communication means 616. Communication means 616 is connected to the internet and communication means 616 transmits the electronic ticket to PDA 620 as well as any other location specified in the customer information. Some of the locations that the electronic ticket can be transmitted to are the customer's home e-mail address, the customer's work e-mail address, the customer's banking institution e-mail address, the customer's credit card company's e-mail address, the customer's phone card company's e-mail address as well as any other address specified in the customer information. The electronic ticket can be transferred from PDA 620 to a personal finance manager program on a personal computer to assist the customer in keeping accurate bookkeeping of expenses.

If one of the e-mail addresses specified in the customer information is a banking institution, the banking institution will receive the electronic ticket and can subtract the amount of the electronic ticket from the customer's account. By having the banking institution subtract each transaction from the customer's account, there is no monthly invoice that needs to be paid.

If PDA 620 is utilized by employees of a company, each employee of the company can use the same e-mail address at the company so that all of the transactions by the employees will be sent to the same e-mail address of the company. Typically, the e-mails would be sent to the accounting department of the company. By having all of the electronic tickets sent to the accounting department of the company, there are no out-of-pocket expenses for the employee which eliminates the need for the employee to wait for the company to reimburse the employees for each of the fueling transactions. Also, the accounting department receives all of the receipts as each fueling transaction occurs which allows the accounting department to keep the company's financial records as accurate as possible. Also, the employee cannot misplace the paper ticket which would cause the employee to not be reimbursed for the fueling transaction.

The customer can also incorporate their credit card number into the customer information stored on PDA 620. By incorporating the customer's credit card number into the customer information, each transaction will be automatically charged to the credit card company and the customer utilizing PDA 620 does not need to carry the credit card with them during fueling transactions.

The customer can incorporate their ATM card number into the customer information (if the ATM card number is different than the credit card number) to withdraw money from an ATM machine without the need to carry the customer's ATM card with them to the ATM machine. Also, the customer can incorporate their phone card number (if the phone card number is different than the credit card or ATM card number) to make phone calls without the need to carry a phone card. Also, if the customer has a prepaid phone card, the electronic ticket for the transaction can be sent to the phone card company to subtract the transaction amount from the available balance left on the card.

In another form, the system shown in FIG. 14 can be configured to diagnose and calibrate a fuel dispenser. As above, located in fuel dispenser 610 is sensor 612 and at least one component. The component can be meter 622, valves (not shown) as well as any other component of fuel dispenser 610.

Processor 614 is connected to sensor 612 and meter 622. PDA 620 emits an infrared beam to sensor 612 and upon the infrared beam being sensed by sensor 612, sensor 612 activates processor 614. Once sensor 612 activates processor 614, PDA 620 is in communication with processor 614, and PDA 620 can be utilized to diagnose and calibrate sensor 612 as well as any component connected to processor 614.

Some of the components that can be connected to processor 614 include meter 622, valves (not shown), switches (not shown), credit card reader (not shown) and any software operating on fuel dispenser 610 that communicates with processor 614. PDA 620 can open and close the valves as well as test each component connected to processor 614 to diagnose any problems.

Once diagnosis of the components connected to processor 614 are completed, PDA 620 can update volume compensation table 626 to ensure accurate volume computations for fuel dispensed and measured by meter 622. Any modifications that alter the accuracy of meter 622 are stored to memory 618 by processor 614. Processor 614 has a real-time clock 628 to time stamp each modification that alters the accuracy of meter 622 before the modification is stored to memory 618.

To access volume compensation table 626, the anti-tamper seal is broken so that the modification to the volume compensation table can be performed utilizing PDA 620.

In another form of the invention, the anti-tamper seal would not need to be broken and PDA 620 could electronically change volume compensation table 626. Volume compensation table 626 is located in memory 618. Memory 618 can be an Electrically Erasable Programmable Read-Only Memory (EEPROM) but other types of memory such as flash memory can be used as well. The EEPROM memory and flash memory allow the ability of update the volume compensation table 626 without removing memory 618.

In one form of the invention, to access volume compensation table 626, a password must be entered into PDA 620. This password protection allows only authorized people to update volume compensation table 626. PDA 620 also can have password protection wherein a proper password must be entered into PDA 620. Password protection for PDA 620 is used to ensure that PDA 620 cannot be used by a person that has stolen or found PDA 620.

Data encryption is utilized in the transactions to protect the customer from having other people intercept the transmission of the customer's information. Also, the data encryption is utilized so that a customer cannot obtain an electronic ticket and then change the ticket to appear that the customer purchased more fuel than was actually purchased. This encryption is also utilized to protect the customer when the customer's credit card information, phone card information and ATM information is being utilized during the transaction.

FIG. 15 shows another form of the invention that works in a manner similar to the form described and shown in FIG. 14. In FIG. 15, however, sensor 612, processor 614, communication means 616, memory 618, volume compensation table 626 and clock 628 are outside of display 624, though in all other respects it is the same as FIG. 14.

Other forms of the invention are also apparent.

For example, in one form, there is a method for transferring an electronic ticket for a transaction. The first step of the method is providing a transaction device having a sensor, a processor and a communication device. The transaction device can be a fuel dispenser. The sensor senses infrared light beams but is not limited to only infrared light beams. The communication device can communicate with the internet.

The next step of the method is activating the sensor with a wireless device, wherein the activation of the sensor initiates a connection with the communication device. The sensor is activated when the wireless device transmits an infrared beam to the sensor. Once the sensor senses the infrared beam, the sensor initiates a connection with the communication device so that the wireless device can communicate with the communication device.

The final step of the method is utilizing the wireless device to transfer an electronic ticket for a transaction to a second location. Based on the customer information stored in the wireless device, the electronic ticket can be transmitted by the communication device to any location specified in the customer information which is stored in the wireless device. Some examples of locations where the electronic ticket can be transmitted are the customer's home e-mail address, the customer's work e-mail address, the customer's banking institution e-mail address, the customer's credit card company's e-mail address and the customer's phone card company's e-mail address.

In another form, there is a display for an apparatus utilized for conducting a transaction. The display includes a sensor connected to the display. A processor is connected to the sensor, a communication means and the display. A wireless device is utilized for activating the sensor. Once the sensor is activated, the sensor activates the processor and the processor activates the communication means. The communication means is utilized for transmitting an electronic ticket for the transaction to a second location.

In another form, there is a display for a fuel dispenser wherein the display includes a sensor connected to the display. A processor is connected to the sensor, a communication means and the display. Also, a wireless device is utilized for activating the sensor. Once the sensor is activated, the sensor activates the processor and the processor activates the communication means. The communication means is utilized for transmitting an electronic ticket for a transaction to a second location.

In another form, there is a method for transferring an electronic ticket for a transaction. The first step of the method is providing a transaction device having a sensor, a processor and a communication device. The second step of the method is activating the sensor with a wireless device wherein the activation of the sensor initiates a connection between the processor and the communication device. The final step of the method is utilizing the wireless device to communicate with the communication device wherein the communication device transfers an electronic ticket for a transaction to a second location.

In another form, there is a method for transmitting an electronic ticket for a fuel dispensing transaction. The first step of the method is providing a fuel dispenser having a sensor, a processor and a communication device. The second step of the method is activating the sensor with a wireless device wherein the activation of the sensor initiates a connection between the processor and the communication device. The final step of the method is utilizing the wireless device to communicate with the communication device wherein the communication device transfers an electronic ticket for a fueling transaction to a second location.

In another form, there is an apparatus for diagnosing and calibrating a fuel dispenser. The fuel dispenser has a sensor and at least one component. A processor is connected to the sensor and at least one component. A wireless device activates the sensor wherein the sensor activates the processor. Once the sensor activates the processor, the wireless device is utilized to diagnose and calibrate at least one component and the sensor.

In another form, there is a method for diagnosing and calibrating a device for conducting transactions. The first step of the method is providing a device for conducting transactions having at least one component, a processor and a sensor. The processor is connected to at least one component and the sensor. A wireless device is used to activate the sensor wherein the activation of the sensor initiates a connection with the processor. Once the sensor initiates the connection with the processor, the wireless device is utilized to diagnose and calibrate at least one component and the sensor.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for use with a fuel dispenser position and a user device operably associated with the fuel dispenser position, said method comprising the steps of:
the fuel dispenser position performing a refueling operation defining a transaction; and
causing the fuel dispenser position to generate and communicate to the user device an electronic transaction receipt.

2. The method as recited in claim 1, wherein the causing step further includes the step of:
wirelessly communicating the electronic transaction receipt to the user device.

3. The method as recited in claim 1, further includes the step of:
the user device communicating to the dispenser position at least one of first information and second information, the first information comprising dispenser-related parameter data, and the second information comprising payment-related data.

4. The method as recited in claim 3, further includes the step of:
causing the fuel dispenser position to perform the refueling operation using the first information and/or the second information.

5. The method as recited in claim 4, further includes the steps of:
the fuel dispenser position performing a transaction authorization and payment process using the second information; and
the fuel dispenser position dispensing fuel in accordance with the first information.

6. The method as recited in claim 1, further includes the step of:
storing the electronic transaction receipt on the user device.

7. The method as recited in claim 1, further includes the steps of:
the user device communicating to the fuel dispenser position a location indicator; and
the fuel dispenser position communicating the electronic transaction receipt to the location specified by the location indicator.

8. The method as recited in claim 7, wherein the location indicator including a network address.

9. The method as recited in claim 7, wherein the location indicator including at least one of an Internet address, a World Wide Web address, an e-mail address, an e-mail account, an electronic messaging address, a point-of-sale (POS) facility designation, and a destination within a refueling environment encompassing at least the fuel dispenser position.

10. The method as recited in claim 3, wherein the dispenser-related parameter data includes at least one of fuel type, fuel amount, and purchase amount, and the payment-related data includes at least one of billing account information and purchase amount.

11. The method as recited in claim 1, wherein the electronic transaction receipt includes at least one of dispenser location, date, time, fuel type, unit price, volume purchased, and amount purchased.

12. The method as recited in claim 1, wherein the user device includes at least one of a cellular phone, a mobile device, a PDA (Personal Digital Assistant), a Palm Pilot, a paging device, and a laptop computer.

13. A method for use with a fuel dispenser position and a user device operably associated with the fuel dispenser position, said method comprising the steps of:
causing the fuel dispenser position to generate an electronic receipt of a refueling transaction; and
communicating the electronic receipt to the user device.

14. The method as recited in claim 13, further includes the step of:
the user device receiving and storing the electronic receipt.

15. The method as recited in claim 13, wherein the communicating step further includes the step of:
wirelessly communicating the electronic receipt from the dispenser position to the user device.

16. The method as recited in claim 13, further includes the step of:
the user device communicating to the dispenser position at least one of first information and second information, the first information comprising dispenser-related parameter data, and the second information comprising payment-related data.

17. The method as recited in claim 16, further includes the step of:
causing the fuel dispenser position to perform at least one refueling transaction task using the first information and/or the second information.

18. The method as recited in claim 17, further includes the steps of:
the fuel dispenser position performing a transaction authorization and payment process using the second information; and
the fuel dispenser position dispensing fuel using the first information.

19. The method as recited in claim 13, further includes the steps of:
the user device communicating to the fuel dispenser position a location indicator; and
the fuel dispenser position communicating the electronic receipt to the location specified by the location indicator.

20. The method as recited in claim 13, further includes the step of:
the fuel dispenser position communicating the electronic receipt to a location different from a user device location.

21. A method for use with a fuel dispenser position, said method comprising the steps of:
providing the fuel dispenser position with a location indicator;
the fuel dispenser position generating an electronic receipt representative of a refueling transaction; and
communicating the electronic receipt to a location specified by the location indicator.

22. The method as recited in claim 21, further includes the steps of:
providing a user device operably associated with the fuel dispenser position; and
communicating the location indicator from the user device to the fuel dispenser position.

23. The method as recited in claim 22, wherein communication of the location indicator includes wireless communication.

24. The method as recited in claim 21, wherein the location indicator including a network address.

25. The method as recited in claim 21, wherein the location indicator including at least one of an Internet address, a World Wide Web address, an e-mail address, an e-mail account, an electronic messaging address, a point-of-sale (POS) facility designation, and a destination within a refueling environment encompassing at least the fuel dispenser position.

26. The method as recited in claim 21, further includes the step of:
communicating the electronic receipt to a user device operably associated with the fuel dispenser position.

27. The method as recited in claim 21, further includes the steps of:
providing a user device operably associated with the fuel dispenser position; and
the user device communicating to the fuel dispenser position at least one of first information and second information, the first information comprising dispenser-related parameter data, and the second information comprising payment-related data.

28. The method as recited in claim 27, further includes the step of:
causing the fuel dispenser position to perform a refueling operation using the first information and/or the second information.

29. The method as recited in claim 28, further includes the steps of:
the fuel dispenser position performing a transaction authorization and payment process using the second information; and
the fuel dispenser position dispensing fuel in accordance with the first information.

30. A method for use with a fuel dispenser position and a user device operably associated with the fuel dispenser position, said method comprising the steps of:
the user device communicating a location indicator to the fuel dispenser position;
the fuel dispenser position generating an electronic receipt representative of a refueling transaction; and
the fuel dispenser position communicating the electronic receipt to a location specified by the location indicator.

31. The method as recited in claim 30, wherein communication of the location indicator includes wireless communication.

32. The method as recited in claim 30, further includes the step of:
communicating the electronic receipt to the user device.

33. The method as recited in claim 30, further includes the step of:
the user device communicating to the fuel dispenser position at least one of first information and second information, the first information comprising dispenser-related parameter data, and the second information comprising payment-related data.

34. The method as recited in claim 33, further includes the step of:
causing the fuel dispenser position to perform a refueling operation using the first information and/or the second information.

35. The method as recited in claim 34, further includes the steps of:
the fuel dispenser position performing a transaction authorization and payment process using the second information; and
the fuel dispenser position dispensing fuel in accordance with the first information.

36. A method for use with a fuel dispenser position, said method comprising the steps of:
the fuel dispenser position generating an electronic transaction receipt representative of a refueling transaction; and
the fuel dispenser position communicating the electronic transaction receipt to a location apart therefrom.

37. The method as recited in claim 36, wherein the communicating step further includes the step of:
communicating the electronic transaction receipt to a user device operably associated with the fuel dispenser position.

38. The method as recited in claim 37, wherein communication of the electronic transaction receipt to the user device includes wireless communication.

39. The method as recited in claim 36, wherein the communicating step further includes the step of:
communicating the electronic transaction receipt to a network location.

40. The method as recited in claim 36, wherein the communicating step further includes the step of:
communicating the electronic transaction receipt to a location specified by a refueling customer operably associated with the fuel dispenser position.

41. The method as recited in claim 36, wherein the communicating step further includes the step of:
communicating the electronic transaction receipt to a location specified in a wireless communication from a user device operably associated with the fuel dispenser position.

42. The method as recited in claim 36, further includes the step of:
the fuel dispenser position receiving information from a user device operably associated with the fuel dispenser position.

43. The method as recited in claim 42, wherein the information includes a location indicator indicative of the location.

44. The method as recited in claim 42, wherein the information includes at least one of first information and second information, the first information comprising dispenser-related parameter data, and the second information comprising payment-related data.

45. The method as recited in claim 44, further includes the step of:
causing the fuel dispenser position to perform a refueling operation using the first information and/or the second information.

46. A system, comprising:
a fuel dispenser position;
said fuel dispenser position being operably configured to generate an electronic receipt representative of a refueling transaction; and
said fuel dispenser position being operably configured further to communicate the electronic receipt to a location apart therefrom.

47. The system as recited in claim 46, further includes:
a wireless communications link, said wireless communications link operably connecting the fuel dispenser position to the location to facilitate communication of the electronic receipt therebetween.

48. The system as recited in claim 46, further includes:
a user device operably associated with said fuel dispenser position.

49. The system as recited in claim 48, wherein said user device being operably configured to communicate to said fuel dispenser position a location indicator indicative of the location.

50. The system as recited in claim 49, wherein said fuel dispenser position being configured further to communicate the electronic receipt to the location in response to and in accordance with the location indicator.

51. The system as recited in claim 49, wherein the location indicator includes at least one of a network address, an Internet address, a World Wide Web address, an e-mail address, an e-mail account, an electronic messaging address, a point-of-sale (POS) facility designation, and a destination within a refueling environment encompassing at least said fuel dispenser position.

52. The system as recited in claim 48, wherein said fuel dispenser position being operably configured further to communicate the electronic receipt to said user device.

53. The system as recited in claim 48, wherein said user device being operably configured further to communicate to said fuel dispenser position at least one of first information and second information, the first information comprising dispenser-related parameter data, and the second information comprising payment-related data.

54. The system as recited in claim 53, wherein said fuel dispenser position being operably configured further to perform at least one refueling transaction task using the first information and/or the second information.

55. The system as recited in claim 54, wherein said fuel dispenser position being operably configured further to perform a transaction authorization and payment process using the second information, and/or to dispense fuel using the first information.

56. A system, comprising:
a fuel dispenser position; and
a user device operably associated with said fuel dispenser position;
said fuel dispenser position being operably configured to generate an electronic receipt representative of a refueling transaction;
said fuel dispenser position being operably configured further to communicate the electronic receipt to said user device and/or to a location apart from said user device.

57. The system as recited in claim 56, wherein communication of the electronic receipt to said user device includes wireless communication.

58. The system as recited in claim 56, wherein said user device being operably configured to receive and store the electronic receipt communicated from said fuel dispenser position.

59. The system as recited in claim 56, wherein said user device being operably configured to communicate to said fuel dispenser position a location indicator indicative of said location.

60. The system as recited in claim 59, wherein said fuel dispenser position being operably configured further to communicate the electronic receipt to said location in response to and in accordance with the location indicator.

61. The system as recited in claim 56, wherein said user device being operably configured to communicate to said fuel dispenser position at least one of first information and second information, the first information comprising dispenser-related parameter data, and the second information comprising payment-related data.

62. The system as recited in claim 61, wherein said fuel dispenser position being operably configured further to perform at least one refueling transaction task using the first information and/or the second information.

63. The system as recited in claim 62, wherein said fuel dispenser position being operably configured further to perform a transaction authorization and payment process using the second information, and/or to dispense fuel using the first information.

64. A fuel dispenser apparatus, comprising:
a fuel dispenser assembly;
an electronic transaction receipt signal generator;
a remote communications module; and
a processor, said processor being operably coupled to said signal generator and to said remote communications module.

65. The apparatus as recited in claim 64, further includes:
a data structure having a remote location indicator, said data structure being operably coupled to said processor.

66. The apparatus as recited in claim 64, wherein said remote communications module further includes:
a wireless communication device.

67. A system in association with a fuel dispenser position, said system comprising:
first means, at the fuel dispenser position, for generating an electronic transaction receipt representative of a refueling transaction; and
second means, at the fuel dispenser position, for communicating the electronic transaction receipt to a location apart from the fuel dispenser position.

68. The system as recited in claim 67, further includes:
a user device operably associated with the fuel dispenser position.

69. The system as recited in claim 68, wherein said second means further includes:
means for wirelessly communicating the electronic transaction receipt to said user device.

70. The system as recited in claim 68, wherein said second means further includes:
means for directing communication of the electronic transaction receipt to a location specified by a location indicator communicated from said user device.

71. The system as recited in claim 68, further includes:
means, at the user device, for communicating to said fuel dispenser position a location indicator indicative of said location, for use by said second means in the communication of the electronic transaction receipt.

72. The system as recited in claim 68, further includes:
means, at the user device, for communicating to said fuel dispenser position at least one of first information and second information, the first information comprising dispenser-related parameter data, and the second information comprising payment-related data.

73. The system as recited in claim 72, further includes:
means, at the fuel dispenser position, for performing at least one refueling transaction task using the first information and/or the second information.

74. A system in association with a fuel dispenser position and a user device operably associated with said fuel dispenser position, said system comprising:
first means, at the fuel dispenser position, for generating an electronic transaction receipt representative of a refueling transaction; and
second means, at the fuel dispenser position, for communicating the electronic transaction receipt to said user device and/or to a location apart from said user device.

75. The system as recited in claim 74, wherein said second means further includes:
means for wirelessly communicating the electronic transaction receipt to said user device.

76. The system as recited in claim 74, further includes:
means, at the user device, for communicating to said fuel dispenser position a location indicator indicative of said location; and
means, in association with said second means, for directing communication of the electronic transaction receipt in accordance with the location indicator communicated from said user device.

77. The system as recited in claim 74, further includes:
means at the user device, for communicating to said fuel dispenser position at least one of first information and second information, the first information comprising dispenser-related parameter data, and the second information comprising payment-related data.

78. The system as recited in claim 77, further includes:
means, at the fuel dispenser position, for performing at least one refueling transaction task using the first information and/or the second information.

79. A method for use with a fuel dispenser position and a user device operably associated with the fuel dispenser position, the fuel dispenser position comprising at least one component, said method comprising the steps of:
establishing a wireless communications link between the user device and the fuel dispenser position; and
causing the user device to perform at least one remote management function involving the fuel dispenser position, using the wireless communications link.

80. The method as recited in claim 79, wherein the causing step further includes the step of:
causing the user device and the fuel dispenser position to cooperatively perform at least one task using at least one communication over the wireless communications link, the at least one task comprising at least one of a diagnostic function, a calibration function, a configuration function, a monitoring function, and a maintenance function.

81. The method as recited in claim 79, wherein the causing step further includes performing at least one of the following operating sequences (i)-(iii):
(i) the user device communicating at least one diagnostic command to the fuel dispenser position, and
the fuel dispenser position conducting a diagnostic operation in accordance with the at least one diagnostic command communicated from the user device;
(ii) the user device communicating at least one configuration command to the fuel dispenser, and
the fuel dispenser position conducting a configuration operation in accordance with the at least one configuration command communicated from the user device; and
(iii) the user device communicating at least one calibration command to the fuel dispenser, and
the fuel dispenser position conducting a calibration operation in accordance with the at least one calibration command communicated from the user device.

82. The method as recited in claim 81, further includes the step of:
the fuel dispenser position storing a calibration history representing a compilation of calibration adjustments each corresponding to a respective calibration operation.

83. The method as recited in 79, further includes the step of:
the fuel dispenser position communicating to the user device over the wireless communications link at least one result realized by performance of the at least one remote management function.

84. A method for use with a fuel dispenser position and a user device operably associated with the fuel dispenser position, the fuel dispenser position comprising at least one component, said method comprising the steps of:
the user device communicating non-refueling transaction related information to the fuel dispenser position; and
the fuel dispenser position running at least one non-refueling transaction related operation in respect to at least one fuel dispenser component, using the non-refueling transaction related information communicated from the user device.

85. The method as recited in claim 84, wherein the communicating step includes wireless communication.

86. The method as recited in claim 84, wherein the non-refueling transaction related information communicated to the fuel dispenser position being adapted to facilitate remote management of the fuel dispenser position by the user device.

87. The method as recited in claim 84, further includes performing at least one of the following operating sequences (i)-(iv):
(i) the communicating step further includes the step of the user device communicating diagnostic-related information to the fuel dispenser position, and
the running step further includes the step of the fuel dispenser position running a diagnostic operation in accordance with the diagnostic-related information communicated from the user device;
(ii) the communicating step further includes the step of the user device communicating configuration-related information to the fuel dispenser position, and
the running step further includes the step of the fuel dispenser position running a configuration operation in accordance with the configuration-related information communicated from the user device;
(iii) the communicating step further includes the step of the user device communicating calibration-related information to the fuel dispenser position, and
the running step further includes the step of the fuel dispenser position running a calibration operation in accordance with the calibration-related information communicated from the user device; and
(iv) the communicating step further includes the step of the user device communicating first information to the fuel dispenser position, the first information comprising maintenance-related information and/or monitoring-related information, and
the running step further includes the step of the fuel dispenser position running a maintenance operation and/or a monitoring operation in accordance with the first information communicated from the user device.

88. The method as recited in 84, further includes the step of:
the fuel dispenser position wirelessly communicating to the user device at least one result realized by the running of the at least one non-refueling transaction related operation.

89. A system, comprising:
a fuel dispenser position having at least one component; and
a user device operably associated with said fuel dispenser position;
said user device being operably configured to perform at least one remote management function involving the fuel dispenser position.

90. The system as recited in claim 89, wherein:
said fuel dispenser position being operably configured to perform at least one dispenser component-related task, the at least one dispenser-component related task comprising at least one of a diagnostic function, a calibration function, a configuration function, a monitoring function, and a maintenance function;
said user device being operably configured to communicate information to said fuel dispenser position for use thereby to facilitate performance of the at least one dispenser component-related task.

91. The system as recited in claim 89, wherein:
the user device being operably configured further to communicate to the fuel dispenser position at least one of (i) at least one diagnostic command, (ii) at least one configuration command, and (iii) at least one calibration command; and
the fuel dispenser position being operably configured to at least one of (i) conduct a diagnostic operation in accordance with the at least one diagnostic command communicated from the user device, (ii) conduct a configuration operation in accordance with the at least one configuration command communicated from the user device, and (iii) conduct a calibration operation in accordance with the at least one calibration command communicated from the user device.

92. The system as recited in claim 91, where said fuel dispenser position further includes:
a memory to store a calibration history representing a compilation of calibration adjustments each corresponding to a respective calibration operation.

93. The system as recited in 89, wherein the fuel dispenser position being operably configured further to wirelessly communicate to the user device at least one result realized by performance of the at least one remote management function.

94. The system as recited in claim 89, wherein communication from the user device to the fuel dispenser position includes wireless communication.

95. A system, comprising:
a fuel dispenser position comprising at least one component; and
a user device operably associated with the fuel dispenser position;
said user device being operably configured to communicate non-refueling transaction related information to said fuel dispenser position; and
said fuel dispenser position being operably configured to run at least one non-refueling transaction related operation in respect to at least one fuel dispenser component, using the non-refueling transaction related information communicated from said user device.

96. The system as recited in claim 95, wherein communication from said user device to said fuel dispenser position includes wireless communication.

97. The system as recited in claim 95, wherein:
said user device being operably configured further to communicate to said fuel dispenser position at least one of (i) diagnostic-related information, (ii) configuration-related information, (iii) calibration-related information, and (iv) first information, the first information comprising maintenance-related information and/or monitoring-related information;
said fuel dispenser position being operably configured further to at least one of (i) run a diagnostic operation in accordance with the diagnostic-related information communicated from said user device, (ii) run a configuration operation in accordance with the configuration-related information communicated from said user device, (iii) run a calibration operation in accordance with the calibration-related information communicated from the user device, and (iv) run a maintenance operation and/or a monitoring operation in accordance with the first information communicated from said user device.

98. The system as recited in 95, wherein said fuel dispenser position being operably configured further to wirelessly communicate to said user device at least one result realized by the running of the at least one non-refueling transaction related operation.

99. An apparatus, comprising:
a fuel dispenser having a component assembly;
a communication unit at the fuel dispenser;
a processor at the fuel dispenser, said processor being operably coupled to said dispenser component assembly and said communication unit;
a user device;
at least one executable remote dispenser management functionality at the user device; and
a wireless communication link between said user device and said fuel dispenser.

100. The apparatus as recited in claim 99, wherein the at least one executable remote dispenser management functionality further includes:
at least one of a diagnostic routine, calibration routine, configuration routine, monitoring routine, and maintenance routine.

101. A system in association with a fuel dispenser position and a user device operably associated with said fuel dispenser position, said fuel dispenser position having at least one component, said system comprising:
means, at the user device, for enabling communication with the fuel dispenser position; and
means, at the user device, for performing at least one remote management function involving the fuel dispenser position.

102. The system as recited in claim 101, further includes:
first means, at the fuel dispenser position, for performing at least one task, the at least one task comprising at least one of a diagnostic function, a calibration function, a configuration function, a monitoring function, and a maintenance function;
second means, at the user device, for communicating information to said fuel dispenser position for use by said first means to facilitate performance of the at least one task.

103. The system as recited in claim 101, further includes:
means, at the user device, for communicating to said fuel dispenser position at least one of (i) at least one diagnostic command, (ii) at least one configuration command, and (iii) at least one calibration command;
means, at the fuel dispenser position, for at least one of (i) conducting a diagnostic operation in accordance with the at least one diagnostic command communicated from the user device, (ii) conducting a configuration operation in accordance with the at least one configuration command communicated from the user device, and (iii) conducting a calibration operation in accordance with the at least one calibration command communicated from the user device.

104. The system as recited in claim 103, further includes:
means, at the fuel dispenser position, for storing a calibration history representing a compilation of calibration adjustments each corresponding to a respective calibration operation.

105. The system as recited in 101, further includes:
means, at the fuel dispenser position, for wirelessly communicating to the user device at least one result realized by performance of the at least one remote management function.

106. The system as recited in claim 101, wherein communication from the user device to the fuel dispenser position includes wireless communication.

107. A system in association with a fuel dispenser position and a user device operably associated with said fuel dispenser position, said fuel dispenser position having at least one component, said system comprising:
means, at the user device, for communicating non-refueling transaction related information to said fuel dispenser position; and
means, at the fuel dispenser position, for running at least one non-refueling transaction related operation in respect to at least one fuel dispenser component, using the non-refueling transaction related information communicated from said user device.

108. The system as recited in claim 107, wherein communication from said user device to said fuel dispenser position includes wireless communication.

109. The system as recited in claim 107, further includes:
means, at the user device, for communicating to said fuel dispenser position at least one of (i) diagnostic-related information, (ii) configuration-related information, (iii) calibration-related information, and (iv) first information, the first information comprising maintenance-related information and/or monitoring-related information; and
means, at the fuel dispenser position, for at least one of (i) running a diagnostic operation in accordance with the diagnostic-related information communicated from said user device, (ii) running a configuration operation in accordance with the configuration-related information communicated from said user device, (iii) running a calibration operation in accordance with the calibration-related information communicated from the user device, and (iv) running a maintenance operation and/or a monitoring operation in accordance with the first information communicated from said user device.

110. The system as recited in 107, further includes:
means, at the fuel dispenser position, for wirelessly communicating to said user device at least one result realized by the running of the at least one non-refueling transaction related operation.

111. A system in association with a fuel dispenser position having at least one dispenser component, said system comprising:
a single circuit board assembly at the fuel dispenser position;
the single circuit board assembly having at least one functionality facilitating a fuel dispensing operation;
the single circuit board assembly comprising;
a wireless communications device,
a display,
an interface assembly, said interface assembly being configured to facilitate interfacing with an off-board assembly comprising a power supply unit, a dispenser valve unit, a flowmeter unit, a fuel pump unit, and a vapor recovery unit,
a communication interface module, said communication interface module being adapted to facilitate interfacing and/or communication with a plurality of communication and/or connection formats, protocols, and/or schemes, and
a processor, said processor being operably coupled to said wireless communications device, said display, said interface assembly, and said communication interface module.
